(19) United States
(12) Patent Application Publication
(10) Pub. No.: US 2023/0261203 A1
(43) Pub. Date: Aug. 17, 2023

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/136,125

(22) Filed: Apr. 18, 2023

Related U.S. Application Data
(63) Continuation of application No. PCT/JP2020/039254, filed on Oct. 19, 2020.

(51) Int. Cl. H01M 4/62; H01M 10/0569; H01M 4/131

(52) U.S. Cl. CPC H01M 4/628; H01M 10/0569; H01M 4/131; H01M 2300/0034

(57) ABSTRACT

The purpose of the present invention is to provide a lithium secondary battery having a high energy density and an excellent cycle characteristic. The present invention relates to a lithium secondary battery having a positive electrode and a negative electrode not having a negative electrode active material, wherein at least a part of a surface of the negative electrode facing the positive electrode is coated with a compound containing an aromatic ring to which two or more elements selected from the group consisting of N, S, and O are each independently bonded.

### BACKGROUND

### Field

The present invention relates to a lithium secondary battery.

### Description of Related Art

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which charge/discharge by transferring lithium ions between a positive electrode and a negative electrode are known to exhibit a high voltage and high energy density. As the typical lithium secondary battery, a lithium ion secondary battery which contains an active material capable of retaining a lithium element in the positive electrode and the negative electrode, and which charges/discharges by delivering or receiving lithium ions between the positive electrode active material and the negative electrode active material is known.

In addition, for the purpose of high energy density, there has been developed a lithium secondary battery that lithium metal is used as the negative electrode active material, instead of a material into which the lithium element can be inserted, such as a carbon-based material. For example, Patent Document 1 discloses a lithium secondary battery including an ultrathin lithium-metal anode, in which a volume energy density exceeding 1000 Wh/L and/or a mass energy density exceeding 350 Wh/kg is realized at the time of discharge at at least a rate of 10 at room temperature. Patent Document 1 discloses that, in such a lithium secondary battery, charge is performed by a direct precipitation of a new lithium metal on the lithium metal as the negative electrode active material.

For the purpose of further improving high energy density and improving productivity, or the like, a lithium secondary battery which does not use a negative electrode active material has been developed. For example, Patent Document 2 discloses a lithium secondary battery including a positive electrode and a negative electrode, and a separation membrane and an electrolyte interposed therebetween. In the aforesaid negative electrode, metal particles formed on a negative electrode current collector are transferred from the positive electrode when the battery is charged and a lithium metal is formed on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.

Patent Document 1: Published Japanese Translation of PCT application No 2019-517722

Patent Document 2: Published Japanese Translation of PCT application No 2019-505971

### SUMMARY

### Technical Problem

As a result of detailed investigation of conventional batteries including those described in the Patent Documents, the present inventors have found that at least either one of their energy density and cycle characteristic is not sufficient.

For example, in the lithium secondary battery which includes a negative electrode having the negative electrode active material, due to the occupation volume or mass of the negative electrode active material, it is difficult to sufficiently increase the energy density and a capacity. In addition, even in an anode free lithium secondary battery of the prior art, which includes a negative electrode not having a negative electrode active material, due to repeated charging/discharging, a dendritic lithium metal is likely to be formed on a surface of the negative electrode, which is likely to cause a short circuit and a decrease in capacity, resulting in insufficient cycle characteristic.

In the anode free lithium secondary battery, a method of applying a large physical pressure on a battery to keep the interface between a negative electrode and a separator at high pressure has also been developed in order to suppress the discrete growth at the time of lithium metal precipitation. Application of such a high pressure however needs a large mechanical mechanism, leading to an increase in the weight and volume of the battery and a reduction in energy density as the entire battery.

The present invention has been made in consideration of the aforesaid problems and a purpose is to provide a lithium secondary battery having a high energy density and excellent in cycle characteristic.

### Solution to Problem

A lithium secondary battery according to an aspect of the present invention has a positive electrode and a negative electrode not having a negative electrode active material, wherein at least a part of a surface of the negative electrode facing the positive electrode is coated with a compound containing an aromatic ring to which two or more elements selected from the group consisting of N, S, and O are each independently bonded.

Because such a lithium secondary battery does not have a negative electrode active material, the volume and mass of the entire battery are reduced as compared with a lithium secondary battery having a negative electrode active material, and the energy density is high in principle. In such a battery, charge/discharge are performed by depositing lithium metal on the surface of the negative electrode and electrolytically dissolving the deposited lithium.

The present inventors have found that the lithium secondary battery in which at least a part of a surface of the negative electrode facing the positive electrode is coated with the compound containing an aromatic ring to which two or more elements selected from the group consisting of N, S, and O are each independently bonded (which will hereinafter also be called “negative-electrode coating agent”) has excellent cycle characteristic. The factors are not necessarily clear, but it is presumed as follows. Because at least one of N, S, or O bonded to the aromatic ring is coordinate-bonded to a metal constituting the negative electrode, and at least one of N, S, or O bonded to the aromatic ring interacts with a lithium ion near the surface of the negative electrode, it is considered that the deposition of the lithium metal on the surface of the negative electrode and the dissolution thereof are assisted. In addition, because the N, S, or O is bonded to the aromatic ring, the negative electrode and the lithium ion interacting with the negative-electrode coating agent are electrically connected by a 7-conjugation of the aromatic ring. Therefore, it is considered that the lithium metal can deposit on the surface of the negative electrode even if the surface of the negative electrode is coated with the negative-electrode coating agent. However, the factors are not limited to those described above, and will be described in more detail in Detailed Description.

It is preferable that the lithium secondary battery further has a separator or a solid electrolyte placed between the positive electrode and the negative electrode. In such an aspect, the positive electrode can be separated from the negative electrode more reliably and a short circuit of the battery can be reliably suppressed further.

It is preferable that the negative-electrode coating agent has one or more N bonded to the aromatic ring. In such an aspect, the strength of the interaction between the negative-electrode coating agent and the lithium ion (lithium element) becomes more suitable and the cycle characteristic of the battery is further improved.

It is preferable that the negative-electrode coating agent is at least one selected from the group consisting of a compound represented by Formula (1) and a derivative of the compound represented by Formula (1).

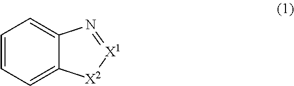

In the formula, X¹ represents any one of C to which X³ is bonded or N, X² represents any one of N to which X⁴ is bonded, S, or O, X³ represents -R¹, -NR¹₂, -OR¹, or -SR¹, X⁴ represents any one of -R², -CO-X, -CS-NX₂, -SO₂-X, -SiX₃, or -OX, R¹ represents a hydrogen atom, an unsubstituted monovalent hydrocarbon group, or a pyridyl group, R² represents a hydrogen atom or a monovalent hydrocarbon group which is optionally substituted, and X represents a monovalent substituent.

In addition, it is more preferable that the negative-electrode coating agent is at least one selected from the group consisting of benzotriazole, benzimidazole, benzimidazolethiol, benzoxazole, benzoxazolethiol, benzothiazole, mercaptobenzothiazole, and derivatives of these compounds.

In such aspects, because the strength of the interaction between the negative-electrode coating agent and the lithium ion becomes more suitable and the electrical connection between the negative electrode and the lithium ion coordinated with the negative-electrode coating agent is further improved, the cycle characteristic of the battery is further improved.

The derivative may be a compound in which one or more substituents selected from the group consisting of a hydrocarbon group which is optionally substituted, an amino group which is optionally substituted, a carboxy group, a sulfo group, and a halogen group are each independently bonded to the aromatic ring.

It is preferable that the lithium secondary battery further has electrolyte solution containing, as a solvent, a compound having at least one of a monovalent group represented by Formula (A) or a monovalent group represented by Formula (B). Here, in the formulae, a wavy line represents a bonding site in the monovalent group.

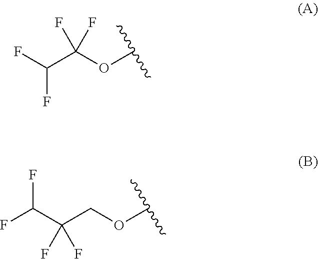 [SMILES: *OC(F)(F)C(F)F ; *OCC(F)(F)C(F)F]

In such an aspect, because a formation of a solid electrolyte interfacial layer (SEI layer) is promoted on the surface of the negative electrode, the cycle characteristic of the battery is further improved. Because the SEI layer has ionic conductivity, reactivity of lithium-metal deposition reaction on the surface of the negative electrode, on which the SEI layer is formed, is uniform in a planar direction of the surface of the negative electrode, and thus the growth of dendritic lithium metal on the negative electrode is suppressed.

In the lithium secondary battery, charging and discharging are performed by depositing lithium metal on the surface of the negative electrode and electrolytically dissolving the deposited lithium.

The negative electrode is preferably an electrode consisting of at least one selected from the group consisting of Cu, Ni, Ti, Fe, and other metals that do not react with Li, alloys of these metals, and stainless steel (SUS). In such an aspect, it has more excellent safety and excellent productivity because it does not need a lithium metal having high flammability for the producing. In addition, such a negative electrode is stable and therefore, a secondary battery obtained using it has an improved cycle characteristic.

In the lithium secondary battery having the negative electrode not having a negative electrode active material, the negative electrode does not have a lithium metal on a surface of the negative electrode before initial charge and/or at an end of discharge. Therefore, the lithium secondary battery has excellent safety and productivity because it does not need a lithium metal having high flammability for the producing.

It is preferable that the lithium secondary battery has an energy density of 350 Wh/kg or more.

The present invention makes it possible to provide a lithium secondary battery having a high energy density and an excellent cycle characteristic.

### BRIEF DESCRIPTION OF DRAWINGS

FIG. 1 is a schematic cross-sectional view of a lithium secondary battery according to First Embodiment.

FIG. 2 is a schematic cross-sectional view of the use of the lithium secondary battery according to First Embodiment.

FIG. 3 is a schematic cross-sectional view of a lithium secondary battery according to Second Embodiment.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

### First Embodiment

Lithium Secondary Battery

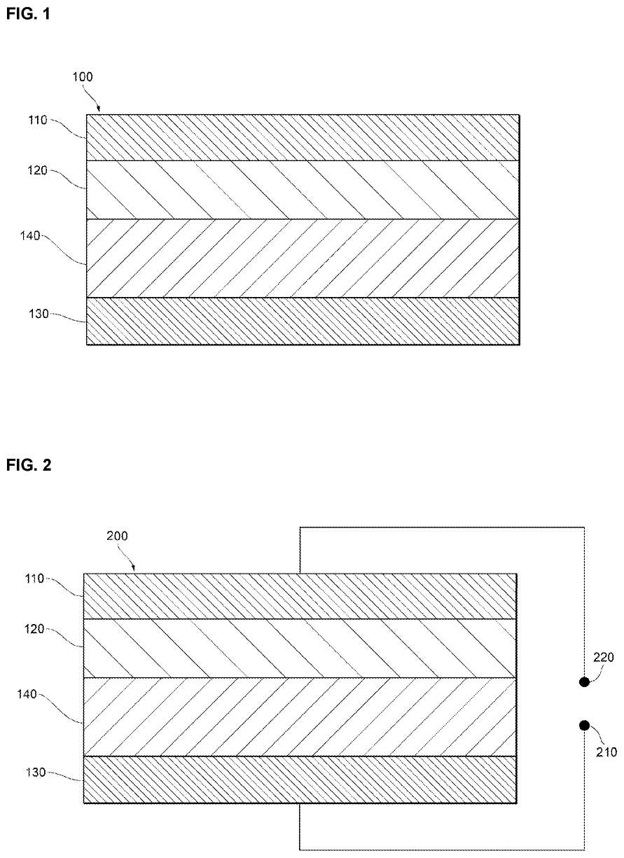

FIG. 1 is a schematic cross-sectional view of a lithium secondary battery of First Embodiment. A lithium secondary battery 100 according to First Embodiment has a positive electrode 120 and a negative electrode 130 not having a negative electrode active material, in which at least a part of a surface of the negative electrode 130 facing the positive electrode is coated with a compound, which is not illustrated in FIG. 1, containing an aromatic ring to which two or more elements selected from the group consisting of N, S, and O (negative-electrode coating agent) are each independently bonded. In addition, in the lithium secondary battery 100, a positive electrode current collector 110 is placed on a side of the positive electrode 120, opposite to a surface facing the negative electrode 130, and a separator 140 is placed between the positive electrode 120 and the negative electrode 130.

Negative Electrode

The negative electrode 130 does not have a negative electrode active material, that is, does not have lithium and an active material which serves as a host for lithium. Therefore, in the lithium secondary battery 100, the volume and mass of the entire battery are reduced as compared with a lithium secondary battery having a negative electrode having a negative electrode active material, and the energy density is high in principle. In the lithium secondary battery 100, charging and discharging are performed by depositing lithium metal on the surface of the negative electrode 130 and electrolytically dissolving the deposited lithium.

The term “lithium metal deposited on the negative electrode” as used herein means the lithium metal deposited on at least one of the surface of the negative electrode, which is coated with the negative-electrode coating agent, or a surface of a solid electrolyte interfacial layer (SEI layer) formed on the surface of the negative electrode, which will be described later. Therefore, in the lithium secondary battery 100, for example, the lithium metal may deposit on the surface of the negative electrode 130, which is coated with the negative-electrode coating agent (interface between the negative electrode 130 and the separator 140).

The term “negative electrode active material” as used herein means a material for retaining, on the negative electrode 130, a lithium ion or a lithium metal, and it may be replaced by the term “a host material for a lithium element (typically, lithium metal)”. Such a retaining mechanism is not particularly limited and examples thereof include intercalation, alloying, and occlusion of metal clusters. Intercalation is typically used.

Such a negative electrode active material is not particularly limited and examples thereof include lithium metal, alloys with lithium metal, carbon-based materials, metal oxides, metals which can be alloyed with lithium, and alloys with the metals. The carbon-based material is not particularly limited and examples thereof include graphene, graphite, hard carbon, mesoporous carbon, carbon nanotube, and carbon nanohorn. The metal oxide is not particularly limited and examples thereof include titanium oxide-based compounds, tin oxide-based compounds, and cobalt oxide-based compounds. Examples of metals which can be alloyed with lithium include silicon, germanium, tin, lead, aluminum, and gallium.

The term negative electrode “does not have a negative electrode active material” as used herein means the content of a negative electrode active material in the negative electrode is 10 mass % or less based on the total amount of the negative electrode. The content of a negative electrode active material in the negative electrode is preferably 5.0 mass % or less and it may be 1.0 mass % or less, 0.1 mass % or less, or 0.0 mass % or less, each based on the total amount of the negative electrode. Since the negative electrode does not have the negative electrode active material or the content of the negative electrode active material in the negative electrode is within the aforesaid range, the energy density of the lithium secondary battery 100 is high.

More specifically, in the negative electrode 130, regardless of the state of charge of the battery, the content of the negative electrode active material other than lithium metal is 10 mass % or less in the entire negative electrode, preferably 5.0 mass % or less, and may be 1.0 mass % or less, 0.1 mass % or less, or 0.0 mass % or less. In addition, in the negative electrode 130, before initial charge and/or at the end of discharge, the content of lithium metal is 10 mass % or less based on the entire negative electrode, preferably 5.0 mass % or less, and may be 1.0 mass % or less, 0.1 mass % or less, or 0.0 mass % or less.

Accordingly, the term “lithium secondary battery having a negative electrode not having a negative electrode active material” can be replaced by the term an anode-free secondary battery, a zero-anode secondary battery, or an anode-less secondary battery. In addition, the term “lithium secondary battery having a negative electrode not having a negative electrode active material” may be replaced by the term “lithium secondary battery having a negative electrode which does not have a negative electrode active material other than lithium metal and does not have a lithium metal before initial charge and/or at the end of discharge” or “lithium secondary battery having a negative electrode current collector which does not have a lithium metal before initial charge and/or at the end of discharge”.

The term “before initial charge” of the battery as used herein means a state from the time when the battery is assembled to the time when the battery is first charged. In addition, “at the end of discharge” of the battery means a state in which the battery voltage is 1.0 V or more and 3.8 V or less.

In the lithium secondary battery 100, a ratio M_{3.0}/M_{4.2} of a mass M_{3.0} of lithium metal deposited on the negative electrode 130 in a state in which the battery voltage is 3.0 V to a mass M_{4.2} of lithium metal deposited on the negative electrode 130 in a state in which the battery voltage is 4.2 V is preferably 20% or less, more preferably 15% or less, and still more preferably 10% or less.

In a typical lithium secondary battery, the capacity of the negative electrode (capacity of the negative electrode active material) is set to be approximately the same as the capacity of the positive electrode (capacity of the positive electrode active material). However, in the lithium secondary battery 100, since the negative electrode 130 does not have a negative electrode active material which is a host material for a lithium element, it is not necessary to specify its capacity. Therefore, since the lithium secondary battery 100 is not limited by the charge capacity due to the negative electrode, the energy density can be increased in principle.

The negative electrode 130 is not particularly limited insofar as it does not have a negative electrode active material and is usable as a current collector. Examples thereof include electrodes consisting of at least one selected from the group consisting of Cu, Ni, Ti, Fe, and other metals that do not react with Li, alloys thereof, and stainless steels (SUS). When a SUS is used as the negative electrode 130, a variety of conventionally known SUSs can be used as its kind. One or more of the negative electrode materials may be used either singly or in combination. The term “metal that does with Li” as used herein means a metal which does not form an alloy under the operation conditions of the lithium secondary battery, reacting with a lithium ion or a lithium metal.

The negative electrode 130 preferably consists of at least one selected from the group consisting of Cu, Ni, Ti, Fe, alloys thereof, and stainless steels (SUS), and more preferably consists of at least one selected from the group consisting of Cu, Ni, alloys thereof, and stainless steels (SUS). The negative electrode 130 still more preferably consists of Cu, Ni, alloys thereof, or stainless steels (SUS). When such a negative electrode is used, the energy density and productivity of the battery tend to be further improved.

The negative electrode 130 is an electrode not having a lithium metal. Therefore, it can be produced without using a highly flammable and highly reactive lithium metal, so that the resulting lithium secondary battery 100 has excellent safety, productivity, and cycle characteristic.

The average thickness of the negative electrode 130 is preferably 4 μm or more and 20 μm or less, more preferably 5 μm or more and 18 μm or less, and still more preferably 6 μm or more and 15 μm or less. In such a mode, since the occupation volume of the negative electrode 130 in the lithium secondary battery 100 decreases, the lithium secondary battery 100 has a more improved energy density.

Negative-Electrode Coating Agent

Because the lithium secondary battery 100 has the negative electrode 130 not having a negative electrode active material, the energy density is high. However, the present inventors have found that there are problems that the short circuit of the battery occurs because, in a case of simply using the negative electrode not having a negative electrode active material, the dendritic lithium metal precipitates on the negative electrode as the battery is charged/discharged, and that the capacity of the battery is lowered because, in a case where the deposited dendritic lithium metal is dissolved, a base portion of the dendritic lithium metal is eluted and some of the lithium metal peels off from the negative electrode and becomes inactive. As a result of intensive research, it has been found that, by coating the surface of the negative electrode 130 with a specific compound, the lithium metal deposited on the negative electrode is suppressed from growing into a dendritic form, whereby the aforesaid problems can be overcome. The present inventors presume the factors as follows, but the factors are not limited thereto.

In the lithium secondary battery 100, at least a part of the surface of the negative electrode 130 facing the positive electrode 120 (and the separator 140) is coated with the compound containing an aromatic ring to which two or more elements selected from the group consisting of N, S, and O are each independently bonded (negative-electrode coating agent). It is presumed that the negative-electrode coating agent is retained on the negative electrode 130 because at least one element selected from the group consisting of N, S, and O is coordinate-bonded to the metal atom constituting the negative electrode 130. Therefore, it is presumed that the negative-electrode coating agent does not detach and/or decompose even after the battery is repeatedly charged/discharged.

It is considered that the negative-electrode coating agent coordinated to the metal atom constituting the negative electrode interacts with the lithium ion present near the surface of the negative electrode by the at least one element selected from the group consisting of N, S, and O. In addition, it is presumed that, because the negative-electrode coating agent contains an aromatic ring to which two or more elements selected from the group consisting of N, S, and O are each independently bonded, the negative-electrode coating agent can form a structure: a metal atom constituting the negative electrode—a first element selected from the group consisting of N, S, and O—an aromatic ring—a second element selected from the group consisting of N, S, and O . . . lithium ion (here, “-” means a covalent bond or a coordination bond, and “ . . . ” means an interaction between the second element and the lithium ion). Therefore, when a voltage that charges the lithium secondary battery 100 is applied, it is considered that the lithium ion interacting with the negative-electrode coating agent obtains an electron from the negative electrode through the π-conjugation of the aromatic ring in the negative-electrode coating agent, resulting in reduction of lithium ion to lithium metal. That is, because the negative-electrode coating agent can serve as a starting point or a base for the lithium-metal deposition reaction on the surface of the negative electrode, it is presumed that, when the negative electrode 130 coated with the negative-electrode coating agent is used, non-uniform deposition reaction of the lithium metal on the surface can be suppressed, and thus the lithium metal deposited on the negative electrode is suppressed from growing into a dendritic form.

Accordingly, the negative-electrode coating agent is not particularly limited insofar as it is a compound containing an aromatic ring to which two or more elements selected from the group consisting of N, S, and O are each independently bonded, that is, a compound having a structure in which two or more of N, S, or O are independently bonded to an aromatic ring. Examples of the aromatic ring include aromatic hydrocarbons such as benzene, naphthalene, azulene, anthracene, and pyrene, and heteroaromatic compounds such as furan, thiophene, pyrrole, imidazole, pyrazole, pyridine, pyridazine, pyrimidine, and pyrazine. Among them, an aromatic hydrocarbon is preferable, benzene or naphthalene is more preferable, and benzene is still more preferable.

In the negative-electrode coating agent, it is preferable that one or more N are bonded to the aromatic ring. That is, the negative-electrode coating agent is preferably a compound having a structure in which N is bonded to the aromatic ring and one or more additional elements selected from the group consisting of N, S, and O, other than the N, are each independently bonded to the aromatic ring. When such a compound in which N is bonded to the aromatic ring is used as the negative-electrode coating agent, the cycle characteristic of the battery tends to be further improved. The factors are not necessarily clear, but it is presumed that, because the strength of interaction between the N and the lithium ion is a suitable strength compared to the strength of interaction between S or O and the lithium ion, the reduction deposition reaction of the lithium ion during charging and the dissolution reaction of the lithium metal during discharging are both promoted. However, the factors are not limited to those described above.

It is preferable that the negative-electrode coating agent is at least one selected from the group consisting of a compound represented by Formula (1) and a derivative of the compound represented by Formula (1). In such a mode, the cycle characteristic of the battery tends to be further improved.

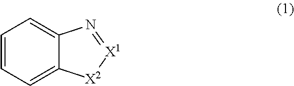

In the formula, X¹ represents any one of C to which X³ is bonded or N, X² represents any one of N to which X⁴ is bonded, S, or O, X³ represents -R¹, -NR¹₂, -OR¹, or -SR¹, X⁴ represents any one of -R², -CO-X, -CS-NX₂, -SO₂-X, -SiX₃, or -OX, R¹ represents a hydrogen atom, an unsubstituted monovalent hydrocarbon group, or a pyridyl group, R² represents a hydrogen atom or a monovalent hydrocarbon group which may be substituted, and X represents any monovalent substituent.

In Formula (1), X¹ represents any one of C to which X³ is bonded or N. The C to which X³ is bonded is C-R¹, C-NR¹₂, C-OR¹, or C-SR¹, and in this case, the leftmost C is bonded to N and X². Here, R¹ is a hydrogen atom, an unsubstituted monovalent hydrocarbon group, or a pyridyl group. The unsubstituted monovalent hydrocarbon group in R¹ is not particularly limited and examples thereof include a linear or branched saturated or unsaturated hydrocarbon group having 1 to 10 carbon atoms. A methyl group or an ethyl group is preferable. The pyridyl group in R¹ is not particularly limited and examples thereof include a 2-pyridyl group, a 3-pyridyl group, and a 4-pyridyl group. A 2-pyridyl group is preferable. Examples of a preferred aspect of X′ include N, C—H, C—SH, C-C₅H₄N, and C—CH₃.

In Formula (1), X² represents any one of N to which X⁴ is bonded, S, or O. The N to which X⁴ is bonded is N-R², N-CO-X, N-CS-NX₂, N-SO₂-X, N-SiX₃, or N-OX, and in this case, the leftmost N is bonded to C of the benzene ring and X¹. Here, R² is a hydrogen atom or a monovalent hydrocarbon group which may be substituted, and X is any monovalent substituent.

The monovalent hydrocarbon group in R², which may be substituted, is not particularly limited and examples thereof include a linear or branched saturated or unsaturated hydrocarbon group having 1 to 10 carbon atoms, which may be substituted. Here, a substituent in the monovalent hydrocarbon group which may be substituted is not particularly limited and examples thereof include a nitrile group, a halogen group, a silyl group, a hydroxy group, an alkoxy group, an aryl group, and an aryloxy group. X is not particularly limited and examples thereof include a hydrogen atom, an unsubstituted linear or branched saturated or unsaturated hydrocarbon group having 1 to 10 carbon atoms, an amino group which may be substituted, an aryl group which may be substituted, a heteroaromatic group which may be substituted, an alkylcarbonyl group, and an arylcarbonyl group. X may be a substituent having no active hydrogen.

Examples of a preferred aspect of X² include S, O, N—H, N—CH₂—C(CH), N—CH₂—Cl, N—CH₂—Si(CH₃)₃, N—CH₂—O—CH₃, N—CH₂—C(═CH₂)—CH₃, N—CH₃, N—CS—NH—C₃HC₅, N—CS—NH—C₃H₂NS, N—CS—NH—CH₂—C₆H₅, N—CS—NC₄H₈, N—CO—CH₃, N—CO—C₆H₅, N—CO—C₅H₄N, N—CO—NH₂, N—CO—C₆H₄Cl, N—CO—C₁₀H₇, N—CO—NH—C₆H₅, N—SO₂—CH₃, N—SO₂—C₆H₅, N—SO₂—C₃H₂N₂(CH₃), N—SO₂—C₄H₃S, N—SO₂—C₅H₄N, and N—O—CO—C₆H₅.

The compound represented by Formula (1) may be a dimer such as Tris-(1-benzotriazolyl)methane and 2,6-bis[(1H-benzotriazole-1-yl)methyl]-4-methylphenol or a multimer such as a trimer, but it is preferable that the compound represented by Formula (1) is a monomer.

Among them, it is more preferable that the negative-electrode coating agent is at least one selected from the group consisting of benzotriazole, benzimidazole, benzimidazolethiol, benzoxazole, benzoxazolethiol, benzothiazole, mercaptobenzothiazole, and derivatives of these compounds. In such a mode, the cycle characteristic of the battery tends to be further improved.

Among them, from a similar standpoint, it is still more preferable that the negative-electrode coating agent is at least one selected from the group consisting of benzotriazole, benzimidazole, benzoxazole, mercaptobenzothiazole, and derivatives of these compounds.

The derivative of the compound represented by Formula (1) or the derivatives of benzotriazole, benzimidazole, benzimidazolethiol, benzoxazole, benzoxazolethiol, benzothiazole, mercaptobenzothiazole are not particularly limited insofar they are compounds derived from these compounds in which a substituent is bonded to a part of these compounds. Examples of such derivatives include compounds in which one or more substituents selected from the group consisting of a hydrocarbon group which may be substituted, an amino group which may be substituted, a carboxy group, a sulfo group, a halogen group, and a silyl group are each independently bonded to the aromatic ring. Examples of such a hydrocarbon group which may be substituted include a monovalent linear or branched saturated or unsaturated hydrocarbon group having 1 to 10 carbon atoms. Here, a substituent in the hydrocarbon group which may be substituted is not particularly limited and examples thereof include a nitrile group, a halogen group, a silyl group, a hydroxy group, an alkoxy group, an aryl group, and an aryloxy group.

Specific examples of the negative-electrode coating agent include 1H-benzotriazole, 5-methyl-1H-benzotriazole, 4-methyl-1H-benzotriazole, 1-benzoyl-1H-benzotriazole, 1-(2-pyridylcarbonyl)benzotriazole, 1-acetyl-1H-benzotriazole, 5-amino-1H-benzotriazole, 2-mercaptobenzothiazole, 6-amino-2-mercaptobenzothiazole, benzimidazole, 2-(2-pyridyl)benzimidazole, benzoxazole, 2-methylbenzoxazole, benzotriazole-5-carboxylic acid, benzotriazole-1-carboxamide, N-(2-propenyl)-1H-benzotriazole-1-carbothioamide, N-(2-thiazolyl)-1H-benzotriazole-1-carbothioamide, N-benzyl-1H-benzotriazole-1-carbothioamide, 1-propargyl-1H-benzotriazole, 1H-benzotriazole-4-sulfonic acid, 1H-benzotriazole-1-acetonitrile, 3H-benzotriazole-5-carboxylic acid, 5-bromo-1H-benzotriazole, 2-(2-hydroxy-5-methylphenyl)benzotriazole, 1-(chloromethyl)-1H-benzotriazole, 1-(methylsulfonyl)-1H-benzotriazole, 1-[(trimethylsilyl)methyl]benzotriazole, 1-(phenoxymethyl)-1H-benzotriazole, 1-(trimethylsilyl)-1H-benzotriazole, 1-(phenylsulfonyl)-1H-benzotriazole, 1-[(1-methyl-1H-imidazol-2-yl)sulfonyl]-1H-benzotriazole, 1-(2-pyridinylsulfonyl)-1H-benzotriazole, 1-(4-chlorobenzoyl)-1H-benzotriazole, 1-(methoxymethyl)-1H-benzotriazole, 1-(2-thienylsulfonyl)-1H-benzotriazole, 1-(3-pyridinylsulfonyl)-1H-benzotriazole, 5-(trifluoromethyl)-1H-1,2,3-benzotriazole, bis(1-benzotriazolyl)methanethione, benzotriazol-1-ylpyrrolidin-1-ylmethanethione, 1-(1-naphthylcarbonyl)-1H-benzotriazole, 1-(2-methyl-allyl)-1H-benzotriazole, 1-(benzoyloxy)-1H-1,2,3-benzotriazole, N-phenyl-1H-1,2,3-benzotriazole-1-carboxamide, phenyl 1H-1,2,3-benzotriazole-5-carboxylate, 1-methyl-1H-1,2,3-benzotriazol-5-amine, tris-(1-benzotriazolyl)methane, and 2,6-bis[(1H-benzotriazole-1-yl)methyl]-4-methylphenol.

Among them, as the negative-electrode coating agent, 1H-benzotriazole, 5-methyl-1H-benzotriazole, 4-methyl-1H-benzotriazole, 1-benzoyl-1H-benzotriazole, 1-(2-pyridylcarbonyl)benzotriazole, 5-amino-1H-benzotriazole, 2-mercaptobenzothiazole, 6-amino-2-mercaptobenzothiazole, benzimidazole, 2-(2-pyridyl)benzimidazole, benzoxazole, 2-methylbenzoxazole, 1-(phenoxymethyl)-1H-benzotriazole, 1-[(1-methyl-1H-imidazol-2-yl)sulfonyl]-1H-benzotriazole, 1-(methoxymethyl)-1H-benzotriazole, benzotriazol-1-ylpyrrolidin-1-ylmethanethione, 1-(1-naphthylcarbonyl)-1H-benzotriazole, 1-(2-methyl-allyl)-1H-benzotriazole, 1-(benzoyloxy)-1H-1,2,3-benzotriazole, tris-(1-benzotriazolyl)methane, or 2,6-bis[(1H-benzotriazole-1-yl)methyl]-4-methylphenol is even still more preferable; and 1H-benzotriazole, 5-methyl-1H-benzotriazole, 4-methyl-1H-benzotriazole, 1-benzoyl-1H-benzotriazole, 1-(2-pyridylcarbonyl)benzotriazole, 2-mercaptobenzothiazole, 6-amino-2-mercaptobenzothiazole, benzimidazole, 2-(2-pyridyl)benzimidazole, 2-methylbenzoxazole, 1-(methoxymethyl)-1H-benzotriazole, 1-(1-naphthylcarbonyl)-1H-benzotriazole, 1-(2-methyl-allyl)-1H-benzotriazole, 1-(benzoyloxy)-1H-1,2,3-benzotriazole, and 2,6-bis[(1H-benzotriazole-1-yl)methyl]-4-methylphenol are particularly preferable.

At least a part of the surface of the negative electrode 130 facing the positive electrode 120 is coated with the negative-electrode coating agent. At least a part of the surface of the negative electrode “is coated with” the negative-electrode coating agent means that a surface having an area ratio of 10% or more in the surface of the negative electrode has the negative-electrode coating agent. The negative electrode 130 has the negative-electrode coating agent in an area ratio of preferably 20% or more, 30% or more, 40% or more, or 50% or more, more preferably 70% or more, and still more preferably 80% or more.

A method of coating the surface of the negative electrode 130 with the negative-electrode coating agent will be described later. In addition, one or more of the negative-electrode coating agents described above may be used either singly or in combination.

Positive Electrode

The positive electrode 120 is not particularly limited insofar as it has a positive electrode active material and is a positive electrode commonly used in a lithium secondary battery, and a known material can be selected as needed, depending on the use of the lithium secondary battery. Because the positive electrode 120 has a positive electrode active material, the stability and the output voltage are high.

In the present specification, the “positive electrode active material” means a material used to retain a lithium element (typically, a lithium ion) in the positive electrode 120, and may be replaced by the term “a host material for the lithium element (typically, a lithium ion)”.

Such a positive electrode active material is not particularly limited and examples thereof include metal oxides and metal phosphates. The metal oxides are not particularly limited and examples thereof include cobalt oxide-based compounds, manganese oxide-based compounds, and nickel oxide-based compounds. The aforesaid metal phosphates are not particularly limited and examples thereof include iron phosphate-based compounds and cobalt phosphate-based compounds. Examples of typical positive electrode active materials include LiCoO₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. One or more of the positive electrode active materials may be used either singly or in combination.

The positive electrode 120 may have a component other than the positive electrode active material. Such a component is not particularly limited and examples thereof include known conductive additives, binders, solid polymer electrolytes, and inorganic solid electrolytes.

The conductive additive to be contained in the positive electrode 120 is not particularly limited and examples thereof include carbon black, single-wall carbon nanotube (SWCNT), multi-wall carbon nanotube (MWCNT), carbon nanofiber (CF), and acetylene black. The binder is not particularly limited and examples thereof include polyvinylidene fluoride, polytetrafluoroethylene, styrene butadiene rubber, acrylic resins, and polyimide resins.

The content of the positive electrode active material in the positive electrode 120 may be, for example, 50 mass % or more and 100 mass % or less based on the entire positive electrode 120. The content of the conductive additive may be, for example, 0.5 mass % or more and 30 mass % or less based on the entire positive electrode 120. The content of the binder in the total amount of the positive electrode 120 may be, for example, 0.5 mass % or more and 30 mass % or less. The total content of the solid polymer electrolyte and the inorganic solid electrolyte may be 0.5 mass % or more and 30 mass % or less based on the entire positive electrode 120.

Positive Electrode Current Collector

The positive electrode current collector 110 is placed on one side of the positive electrode 120. The positive electrode current collector 110 is not particularly limited insofar as it is a conductor not reactive with a lithium ion in the battery. Examples of such a positive electrode current collector include aluminum.

The average thickness of the positive electrode current collector 110 is preferably 4 μm or more and 20 μm or less, more preferably 5 μm or more and 18 μm or less, and still more preferably 6 μm or more and 15 μm or less. In such a mode, an occupation volume of the positive electrode current collector 110 in the lithium secondary battery 100 decreases and the resulting lithium secondary battery 100 therefore has a more improved energy density.

Separator

The separator 140 is a member for separating the positive electrode 120 from the negative electrode 130 to prevent a short circuit of the battery and in addition, for securing the ionic conductivity of a lithium ion which serves as a charge carrier between the positive electrode 120 and the negative electrode 130. It is composed of a material not having electronic conductivity and unreactive to lithium ion. The separator 140 also has a role of retaining electrolyte solution. There are no particular restrictions on the separator 140 insofar as it can play the aforesaid role. The separator 140 can be composed of, for example, a porous polyethylene (PE) film, a polypropylene (PP) film, or a laminated structure thereof.

The separator 140 may be covered with a separator coating layer. The separator coating layer may cover both of the surfaces of the separator 140 or may cover only one of them. The separator coating layer is not particularly limited insofar as it is a member having ionic conductivity and unreactive to a lithium ion and is preferably capable of firmly adhering the separator 140 to a layer adjacent to the separator 140. Such a separator coating layer is not particularly limited and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may be a member obtained by adding, to the aforesaid binder, inorganic particles such as silica, alumina, titania, zirconia, magnesium oxide, magnesium hydroxide, or lithium nitrate. The separator 140 embraces a separator having a separator coating layer.

The average thickness of the separator 140 is preferably 30 μm or less, more preferably 25 μm or less, and still more preferably 20 μm or less. In such a mode, the occupation volume of the separator 140 in the lithium secondary battery 100 decreases and therefore, the resulting lithium secondary battery 100 has a more improved energy density. The average thickness of the separator 140 is preferably 5 μm or more, more preferably 7 μm or more, and still more preferably 10 μm or more. In such a mode, the positive electrode 120 can be separated from the negative electrode 130 more reliably and a short circuit of the resulting battery can be suppressed further.

Electrolyte Solution

The lithium secondary battery 100 preferably has electrolyte solution. In the lithium secondary battery 100, the separator 140 may be wetted with the electrolyte solution or the electrolyte solution may be sealed together with a stacked body of the positive electrode current collector 110, the positive electrode 120, the separator 140, and the negative electrode 130 inside a hermetically sealed container. The electrolyte solution contains an electrolyte and a solvent. It is solution having ionic conductivity and serves as a conductive path of a lithium ion. Therefore, in the mode including the electrolyte solution, an internal resistance of the battery is further reduced, and the energy density, capacity, and cycle characteristics are further improved.

The electrolyte solution preferably contains, as a solvent, a fluorinated alkyl compound having at least one of a monovalent group represented by Formula (A) or a monovalent group represented by Formula (B).

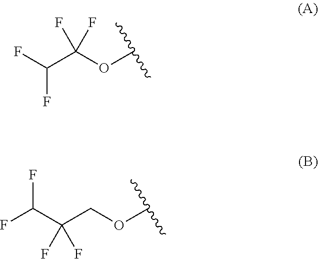 [SMILES: *OC(F)(F)C(F)F ; *OCC(F)(F)C(F)F]

Here, in the formulae, a wavy line represents a bonding site in the monovalent group.

Generally, in an anode-free lithium secondary battery having electrolyte solution, a solid electrolyte interfacial layer (SEI layer) is formed on the surface of a negative electrode or the like by decomposing solvent or the like in the electrolyte solution. Due to the SEI layer in the lithium secondary battery, further decomposition of components in the electrolyte solution, irreversible reduction of lithium ions caused by the decomposition, generation of gas, and the like are suppressed. In addition, because the SEI layer has ionic conductivity, reactivity of lithium-metal deposition reaction on the surface of the negative electrode, on which the SEI layer is formed, is uniform in a planar direction of the surface of the negative electrode. Therefore, promoting the formation of the SEI layer is very important for improving the performance of an anode-free lithium secondary battery. The present inventors have found that, in the lithium secondary battery 100 in which the surface of the negative electrode is coated with the negative-electrode coating agent, by using the aforesaid fluorinated alkyl compound as a solvent, the SEI layer is easily formed on the surface of the negative electrode, and the growth of dendritic lithium metal on the negative electrode is further suppressed, and thus the cycle characteristic is further improved. The factors are not necessarily clear, but the following factors can be considered.

It is considered that not only the lithium ions but also the aforesaid fluorinated alkyl compound as a solvent are reduced on the negative electrode during charge of the lithium secondary battery 100, particularly during initial charge. The portion represented by Formula (A) and the portion represented by Formula (B) in the fluorinated alkyl compound have high reactivity of oxygen atoms due to being substituted with a large number of fluorine. Therefore, it is presumed that a part or all of the portion represented by Formula (A) and the portion represented by Formula (B) are likely to be eliminated. As a result, during charge of the lithium secondary battery 100, a part or all of the portion represented by Formula (A) and the portion represented by Formula (B) are absorbed on the surface of the negative electrode, and since the SEI layer is formed starting from the absorbed portion, it is presumed that the SEI layer is likely to be formed in the lithium secondary battery 100. In addition, because the negative electrode 130 has the negative-electrode coating agent that is presumed to interact with the lithium ion, it is considered that a large amount of lithium ions are present in the vicinity when the SEI layer is formed, and an SEI layer having a high lithium element concentration is formed. As a result, in the lithium secondary battery 100 in which the surface of the negative electrode is coated with the negative-electrode coating agent, by using the aforesaid fluorinated alkyl compound as a solvent, it is presumed that an SEI layer having an appropriate thickness and high ionic conductivity is easily formed, and thus the cycle characteristic is further improved.

Therefore, according to the mode of including the electrolyte solution containing the aforesaid fluorinated alkyl compound as a solvent, even though the SEI layer is easily formed, the internal resistance of the battery is low and the rate capability is excellent. That is, the cycle characteristic and the rate capability are further improved. The “rate capability” means a performance capable of charging/discharging with large current, and it is known that the rate capability is excellent when the internal resistance of the battery is low.

A compound “contained as a solvent” as used herein means that, in the usage environment of lithium secondary batteries, it is sufficient that the compound alone or a mixture of the compound with other compounds is a liquid, and furthermore, it is sufficient that the electrolyte can be dissolved to form electrolyte solution in solution phase.

Examples of such a fluorinated alkyl compound include compounds having an ether bond (which will hereinafter be called “ether compounds”), compounds having an ester bond, and compounds having a carbonate bond. From the standpoint of further improving solubility of the electrolyte in the electrolyte solution and from the standpoint that the SEI layer is more easily formed, the fluorinated alkyl compound is preferably an ether compound.

Examples of the ether compound as the fluorinated alkyl compound include ether compounds having both the monovalent group represented by Formula (A) and the monovalent group represented by Formula (B) (which will hereinafter also be called “first fluorine solvents”), ether compounds that has the monovalent group represented by Formula (A) and does not have the monovalent group represented by Formula (B) (which will hereinafter also be called “second fluorine solvents”), and ether compounds that does not have the monovalent group represented by Formula (A) and has the monovalent group represented by Formula (B) (which will hereinafter also be called “third fluorine solvents”).

Examples of the first fluorine solvents include 1,1,2,2-tetrafluoroethyl-2,2,3,3-tetrafluoropropyl ether, 1,1,2,2-tetrafluoroethyl-2,2,3,3-tetrafluoropropyl diethoxymethane, and 1,1,2,2-tetrafluoroethyl-2,2,3,3-tetrafluoropropyl diethoxypropane. From the standpoint of effectively and reliably exhibiting the effects of fluorinated alkyl compound mentioned above, 1,1,2,2-tetrafluoroethyl-2,2,3,3-tetrafluoropropyl ether is preferable as the first fluorine solvent.

Examples of the second fluorine solvents include 1,1,2,2-tetrafluoroethyl-2,2,2-trifluoroethyl ether, methyl-1,1,2,2-tetrafluoroethyl ether, ethyl-1,1,2,2-tetrafluoroethyl ether, propyl-1,1,2,2-tetrafluoroethyl ether, 1H,1H,5H-perfluoropentyl-1,1,2,2-tetrafluoroethyl ether, and 1H,1H,5H-octafluoropentyl-1,1,2,2-tetrafluoroethyl ether. From the standpoint of effectively and reliably exhibiting the effects of fluorinated alkyl compound mentioned above, 1,1,2,2-tetrafluoroethyl-2,2,2-trifluoroethyl ether, methyl-1,1,2,2-tetrafluoroethyl ether, ethyl-1,1,2,2-tetrafluoroethyl ether, or 1H,1H,5H-octafluoropentyl-1,1,2,2-tetrafluoroethyl ether is preferable as the second fluorine solvent.

Examples of the third fluorine solvents include difluoromethyl-2,2,3,3-tetrafluoropropyl ether, trifluoromethyl-2,2,3,3-tetrafluoropropyl ether, fluoromethyl-2,2,3,3-tetrafluoropropyl ether, and methyl-2,2,3,3-tetrafluoropropyl ether. From the standpoint of effectively and reliably exhibiting the effects of fluorinated alkyl compound mentioned above, difluoromethyl-2,2,3,3-tetrafluoropropyl ether is preferable as the third fluorine solvent.

The electrolyte solution may contain a solvent having neither the monovalent group represented by Formula (A) nor the monovalent group represented by Formula (B). Such a solvent is not particularly limited and examples thereof include solvents not containing fluorine, such as dimethyl ether, triethylene glycol dimethyl ether, dimethoxyethane, diethylene glycol dimethyl ether, acetonitrile, dimethyl carbonate, diethyl carbonate, ethyl methyl carbonate, ethylene carbonate, propylene carbonate, chloroethylene carbonate, methyl acetate, ethyl acetate, propyl acetate, methyl propionate, ethyl propionate, trimethyl phosphate, and triethyl phosphate; and solvents containing fluorine, such as methyl nonafluorobutyl ether, ethyl nonafluorobutyl ether, 1,1,1,2,2,3,4,5,5,5-decafluoro-3-methoxy-4-trifluoromethylpentane, methyl-2,2,3,3,3-pentafluoropropyl ether, 1,1,2,3,3,3-hexafluoropropyl methyl ether, ethyl-1,1,2,3,3,3-hexafluoropropyl ether, and tetrafluoroethyl tetrafluoropropyl ether.

One or more of the solvents described above, including the aforesaid fluorinated alkyl compound, may be used either singly or in combination.

The content of the fluorinated alkyl compound in the electrolyte solution is not particularly limited, but is, based on the total amount of the solvent components in the electrolyte solution, preferably 40 vol. % or more, more preferably 50 vol. % or more, still more preferably 60 vol. % or more, and even more preferably 70 vol. % or more. When the content of the fluorinated alkyl compound is within the aforesaid range, because the SEI layer is more easily formed, the cycle characteristic of the battery tends to be further improved. The upper limit of the content of the fluorinated alkyl compound is not particularly limited, and the content of the fluorinated alkyl compound may be 100 vol. % or less, 95 vol. % or less, 90 vol. % or less, or 80 vol. % or less based on the total amount of the solvent components in the electrolyte solution.

There are no particular restrictions on the electrolyte which is contained in the electrolyte solution insofar as it is a salt. Examples of the electrolyte include salts of Li, Na, K, Ca, and Mg. As the electrolyte, a lithium salt is preferred. The lithium salt is not particularly limited and examples thereof include LiI, LiCI, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiBF₂(C₂O₄), LiB(O₂C₂H₄)₂, LiB(O₂C₂H₄)F₂, LiB(OCOCF₃)₄, LiNO₃, and Li₂SO₄. One or more of the lithium salts may be used either singly or in combination.

The concentration of the electrolyte in the electrolyte solution is not particularly limited, but is preferably 0.5 M or more, more preferably 0.7 M or more, still more preferably 0.9 M or more, and even more preferably 1.0 M or more. When the concentration of the electrolyte is within the aforesaid range, the SEI layer is more easily formed and the internal resistance tends to be further reduced. The upper limit of the concentration of the electrolyte is not particularly limited, and the concentration of the electrolyte may be 10.0 M or less, 5.0 M or less, or 2.0 M or less.

Use of Lithium Secondary Battery

FIG. 2 shows one mode of the use of the lithium secondary battery of the present embodiment. With respect to the lithium secondary battery 100, the lithium secondary battery 200 has a positive electrode terminal 220 and a negative electrode terminal 210 for connecting the lithium secondary battery to an external circuit and these terminals are bonded to the positive electrode current collector 110 and the negative electrode 130, respectively. The lithium secondary battery 200 is charged/discharged by connecting the negative electrode terminal 210 to one end of the external circuit and the positive electrode terminal 220 to the other end of the external circuit.

The lithium secondary battery 200 is charged by applying a voltage between the positive electrode terminal 220 and the negative electrode terminal 210 to cause a current flow from the negative electrode terminal 210 to the positive electrode terminal 220 through the external circuit. By charging the lithium secondary battery 200, the lithium metal deposits on the negative electrode.

In the lithium secondary battery 200, the solid electrolyte interfacial layer (SEI layer) is formed on the surface of the negative electrode 130 (at the interface between the negative electrode 130 and the separator 140), which is coated with the negative-electrode coating agent, by the first charge (initial charge) after assembling the battery. The SEI layer to be formed is not particularly limited and it may contain a lithium-containing inorganic compound or a lithium-containing organic compound. The typical average thickness of the SEI layer is 1 nm or more and 10 μm or less.

When the positive electrode terminal 220 and the negative electrode terminal 210 are connected to the charged lithium secondary battery 200, the lithium secondary battery 200 is discharged. As a result, the deposition of the lithium metal formed on the negative electrode is electrolytically eluted.

Method of Producing Lithium Secondary Battery

A method of producing the lithium secondary battery 100 as shown in FIG. 1 is not particularly limited insofar as it can provide a lithium secondary battery equipped with the aforesaid configuration and examples of the method include the method as follows.

First, the positive electrode 120 is prepared by a known producing method or by purchasing a commercially available one. The positive electrode 120 may be produced in the following manner. Such a positive electrode active material as mentioned above, a known conductive additive, and a known binder are mixed together to obtain a positive electrode mixture. The mixing ratio of them may be, for example, 50 mass % or more and 99 mass % or less of the positive electrode active material, 0.5 mass % or more and 30 mass % or less of the conductive additive, and 0.5 mass % or more and 30 mass % or less of the binder based on the entire positive electrode mixture. The positive electrode mixture thus obtained is applied onto one of the surfaces of a metal foil (for example, Al foil) serving as a positive electrode current collector and having a predetermined thickness (for example, 5 μm or more and 1 mm or less), followed by press molding. The molded material thus obtained is punched into a predetermined size to obtain a positive electrode 120 formed on a positive electrode current collector 110.

Next, a negative electrode 130 is produced which is coated with the negative-electrode coating agent at least a part of both surfaces or one surface. First, the negative electrode material, for example, a metal foil (such as an electrolytic Cu foil) having a thickness of 1 μm or more and 1 mm or less is washed with a sulfamic-acid-containing solvent. Next, after washing the negative electrode material with water, the negative electrode material is immersed in a solution containing the aforesaid negative-electrode coating agent (for example, solution in which the negative-electrode coating agent is contained in an amount of 0.01 vol. % or more and 10 vol. % or less), and dried in the atmosphere, whereby the negative electrode material is coated with the negative-electrode coating agent. At this time, by masking one surface of the negative electrode material, the negative-electrode coating agent may be applied onto only one surface. The negative electrode 130 can be obtained by punching the negative electrode material coated with the negative-electrode coating agent into a predetermined size in this manner.

In the producing step of the negative electrode 130, the order of the coating of the negative-electrode coating agent and the punching process of the negative electrode material may be reversed. That is, the negative electrode 130 may be produced by punching the washed negative electrode material into a predetermined size, and then coating the surface thereof with the negative-electrode coating agent by the aforesaid method. However, according to the method of producing the negative electrode in which the negative electrode material is punched out after coating the negative electrode material with the negative-electrode coating agent, the negative electrode coated with the negative-electrode coating agent can be easily produced by a roll-to-roll method. Therefore, such a producing method is preferable.

Next, a separator 140 having the aforesaid configuration is prepared. As the separator 140, a separator produced by a conventionally known method or a commercially available one may be used.

The electrolyte solution may be prepared by dissolving the aforesaid electrolyte (typically, a lithium salt) in the aforesaid solvent.

The positive electrode current collector 110 on which the positive electrode 120 is formed, the separator 140, and the negative electrode 130 coated with the negative-electrode coating agent, which are obtained as described above, are stacked in order of mention, to obtain a stacked body as shown in FIG. 1. In a case where only one surface of the negative electrode 130 is coated with the negative-electrode coating agent, the stacked body is formed such that the surface faces the positive electrode 120 (and the separator 140). The stacked body obtained as described above is encapsulated, together with the electrolyte solution in a hermetically sealing container to obtain a lithium secondary battery 100. The hermetically sealing container is not particularly limited and examples thereof include a laminate film.

### Second Embodiment

Lithium Secondary Battery

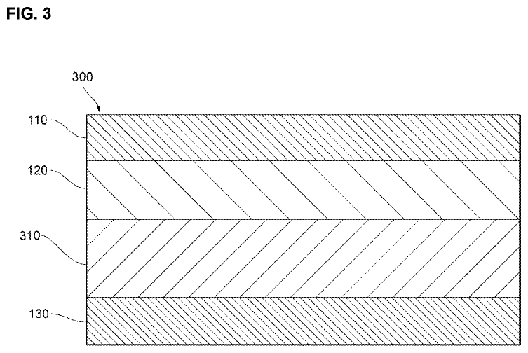

FIG. 3 is a schematic cross-sectional view of the lithium secondary battery of Second Embodiment. A lithium secondary battery 300 according to Second Embodiment has a positive electrode 120 and a negative electrode 130 not having a negative electrode active material, in which at least a part of a surface of the negative electrode 130 facing the positive electrode is coated with a compound, which is not illustrated in FIG. 3, containing an aromatic ring to which two or more elements selected from the group consisting of N, S, and O (negative-electrode coating agent) are each independently bonded. In addition, in the lithium secondary battery 300, a positive electrode current collector 110 is placed on a side of the positive electrode 120, opposite to a surface facing the negative electrode 130, and a solid electrolyte 310 is placed between the positive electrode 120 and the negative electrode 130.

The configuration and preferred modes of the positive electrode current collector 110, the positive electrode 120, the negative electrode 130, and the negative-electrode coating agent are the same as those of the lithium secondary battery 100 in First Embodiment. The lithium secondary battery 300 has the same effects as the lithium secondary battery 100 described above. The lithium secondary battery 300 may include electrolyte solution as included in the lithium secondary battery 100.

Solid Electrolyte

In general, a battery containing liquid electrolyte tends to be exposed to different physical pressures, which are applied from the electrolyte to the surface of a negative electrode, at different locations due to the shaking of the liquid. On the other hand, since the lithium secondary battery 300 has the solid electrolyte 310, a pressure applied from the solid electrolyte 310 to the surface of the negative electrode 130 becomes uniform and the shape of a lithium metal deposited on the surface of the negative electrode 130 can be made more uniform. This means that in such a mode, a lithium metal which deposits on the surface of the negative electrode 130 is suppressed further from growing into a dendritic form and the resulting lithium secondary battery 300 therefore has a more excellent cycle characteristic.

The solid electrolyte 310 is not particularly limited insofar as it is used generally for a lithium solid secondary battery and a known material can be selected as needed, depending on the use of the lithium secondary battery 300. The solid electrolyte 310 preferably has ionic conductivity and no electric conductivity. Since the solid electrolyte 310 has ionic conductivity and no electric conductivity, the resulting lithium secondary battery 300 has more reduced internal resistance and in addition, the lithium secondary battery 300 is prevented from causing a short circuit inside thereof. As a result, the lithium secondary battery 300 therefore has a more excellent energy density, capacity, and cycle characteristic.

The solid electrolyte 310 is not particularly limited and examples thereof include those containing a resin and a lithium salt. The resin is not particularly limited and examples thereof include resins having an ethylene oxide unit in a main chain and/or a side chain, acrylic resins, vinyl resins, ester resins, nylon resins, polysiloxanes, polyphosphazene, polyvinylidene fluoride, polymethyl methacrylate, polyamides, polyimides, aramids, polylactic acid, polyethylenes, polystyrenes, polyurethanes, polypropylenes, polybutylenes, polyacetals, polysulfones, and polytetrafluoroethylene. One or more of the aforesaid resins may be used either singly or in combination.

The lithium salt contained in the solid electrolyte 310 is not particularly limited and examples thereof include salts as lithium salts that can be contained in the electrolyte solution of the lithium secondary battery 100 mentioned above. One or more of the aforesaid lithium salts may be used either singly or in combination.

Generally, the content ratio of the lithium salt to the resin in the solid electrolyte is determined by a ratio ([Li]/[O]) of lithium atoms of the lithium salt to oxygen atoms of the resin. In the solid electrolyte 310, a content ratio of the lithium salt to the resin is adjusted so that the aforesaid ratio ([Li]/[O]) is preferably 0.02 or more and 0.20 or less, more preferably 0.03 or more and 0.15 or less, and still more preferably 0.04 or more and 0.12 or less.

The solid electrolyte 310 may contain a component other than the aforesaid resin and lithium salt. Such a component is not particularly limited and examples thereof include solvents and salts other than lithium salts. The salts other than lithium salts are not particularly limited and examples thereof include salts of Na, K, Ca, and Mg. The solvent is not particularly limited and examples thereof include those mentioned as the solvent of the electrolyte solution which can be contained in the lithium secondary battery 100. One or more of these solvents and salts other than lithium salts may be used either singly or in combination.

The average thickness of the solid electrolyte 310 is preferably 20 μm or less, more preferably 18 μm or less, and still more preferably 15 μm or less. In such a mode, an occupation volume of the solid electrolyte 310 in the lithium secondary battery 300 decreases so that the resulting lithium secondary battery 300 has a more improved energy density. In addition, the average thickness of the solid electrolyte 310 is preferably 5 μm or more, more preferably 7 μm or more, and still more preferably 10 μm or more. In such a mode, the positive electrode 120 can be separated from the negative electrode 130 more reliably and a short circuit of the resulting battery can be suppressed further.

The solid electrolyte 310 embraces a gel electrolyte. The gel electrolyte is not particularly limited and examples thereof include those containing a polymer, an organic solvent, and a lithium salt. The polymer in the gel electrolyte is not particularly limited and examples thereof include copolymers of polyethylene and/or polyethylene oxide, polyvinylidene fluoride, and copolymers of polyvinylidene fluoride and hexafluoropropyrene.

Method of Producing Secondary Battery

The lithium secondary battery 300 can be produced in a manner similar to that of the lithium secondary battery 100 of First Embodiment, except for the use of the solid electrolyte instead of the separator.

The method of producing the solid electrolyte 310 is not particularly limited insofar as it is a method capable of providing the aforesaid solid electrolyte 310 and it may be performed, for example, as follows. A resin and a lithium salt conventionally used for a solid electrolyte (for example, the aforesaid resin as a resin which can be contained in the solid electrolyte 310, and a lithium salt) are dissolved in an organic solvent (for example, N-methylpyrrolidone or acetonitrile). The solution thus obtained is cast on a molding substrate to have a predetermined thickness and thus, the solid electrolyte 310 is obtained. The mixing ratio of the resin and the lithium salt may be determined based on the ratio ([Li]/[O]) of lithium atoms of the lithium salt to oxygen atoms of the resin, as described above. The aforesaid ratio ([Li]/[O]) is, for example, 0.02 or more and 0.20 or less. The molding substrate is not particularly limited and, for example, a PET film or a glass substrate may be used.

Modification Example

The aforesaid present embodiments are examples for describing the present invention. They do not intend to limit the present invention only thereto and the present invention may have various modifications without departing from the gist thereof.

For example, in the lithium secondary battery 100 of First Embodiment, the separator 140 may be formed on both surfaces of the negative electrode 130. In this case, the lithium secondary battery has a structure in which the following components are stacked in order of mention: positive electrode current collector/positive electrode/separator/negative electrode/separator/positive electrode/positive electrode current collector. The lithium secondary battery in such a mode has more improved capacity.

The lithium secondary battery 300 may be a lithium solid secondary battery. A battery in such a mode does not need electrolyte solution so that it is free from a problem of electrolyte solution leakage and has more improved safety.

The lithium secondary battery 100 may not have the separator 140. In such a case, it is desirable that the positive electrode 120 and the negative electrode 130 are fixed at a sufficient distance so as not to cause a short circuit of the battery due to contact between the positive electrode 120 and the negative electrode 130.

In the lithium secondary batteries in the embodiments, a terminal for connecting to an external circuit may be attached to the positive electrode current collector and/or the negative electrode. For example, a metal terminal (for example, Al, Ni, or the like) having a length of 10 μm or more and 1 mm or less may be bonded to one or both of the positive electrode current collector and the negative electrode. For bonding, a conventionally known method may be used and for example, ultrasonic welding is usable.

The term “an energy density is high” or “has a high energy density” as used herein means the capacity of a battery per total volume or total mass is high. It is preferably 800 Wh/L or more or 350 Wh/kg or more, more preferably 900 Wh/L or more or 400 Wh/kg or more, and still more preferably 1000 Wh/L or more or 450 Wh/kg or more.

The term “having an excellent cycle characteristic” as used herein means a decreasing ratio of the capacity of a battery is small before and after the expected number of charging/discharging cycles in ordinary use. Described specifically, it means that when a first discharge capacity after the initial charge and a discharge capacity after the number of charging/discharging cycles expected in ordinary use are compared, the discharge capacity after charging/discharging cycles has hardly decreased compared with the first discharge capacity after the initial charge. The “number expected in ordinary use” varies depending on the usage of the lithium secondary battery and it is, for example, 30 times, 50 times, 70 times, 100 times, 300 times, or 500 times. The term “discharge capacity after charging/discharging cycles hardly decreased compared with the first discharge capacity after the initial charge” means, though differing depending on the usage of the lithium secondary battery, that the discharge capacity after charging/discharging cycles is, for example, 60% or more, 65% or more, 70% or more, 75% or more, 80% or more, or 85% or more, each in the first discharge capacity after the initial charge.

### EXAMPLES

The present invention will hereinafter be described in detail by Examples and Comparative Examples. The present invention is not limited by the following Examples.

### Example 1

A lithium secondary battery was produced as follows. First, an electrolytic Cu foil having a thickness of 10 μm was washed with a sulfamic-acid-containing solvent, and then washed with water. Subsequently, the electrolytic Cu foil was immersed in a solution containing 1H-benzotriazole as the negative-electrode coating agent, dried, and further washed with water to obtain a Cu foil coated with the negative-electrode coating agent. The Cu foil thus obtained was punched into a predetermined size (45 mm×45 mm) to obtain a negative electrode.

As a separator, a separator having a thickness of 16 μm and a predetermined size (50 mm×50 mm), in which both surfaces of a 12 μm polyethylene microporous film were coated with a 2 μm-thick polyvinylidene fluoride (PVdF), was prepared.

A positive electrode was produced as follows. A mixture of 96 parts by mass of LiNi_{0.85}Co_{0.12}Al_{0.03}O₂ as a positive electrode active material, 2 parts by mass of carbon black as a conductive additive, and 2 parts by mass of polyvinylidene fluoride (PVdF) as a binder was applied onto one side of a 12 μm Al foil as a positive electrode current collector, followed by pressing molding. The molded material thus obtained was punched into a predetermined size (40 mm×40 mm) to obtain a positive electrode formed on the positive electrode current collector.

As electrolyte solution, LiN(SO₂F)₂ (LiFSI) was dissolved in dimethoxyethane (DME) to prepare a 1.0 M LiFSI solution. Hereinafter, such electrolyte solution is called as “electrolyte solution 1”.

The positive electrode formed on the positive electrode current collector, the separator, and the negative electrode coated with 1H-benzotriazole as the negative-electrode coating agent, which were obtained as described above, were stacked in order of mention, to obtain a stacked body as shown in FIG. 1. The surface of the negative electrode facing the separator was coated with 1H-benzotriazole. A 100 μm Al terminal and a 100 μm Ni terminal were connected to the positive electrode current collector and the negative electrode by ultrasonic welding, respectively, and then the laminate is inserted into a laminated outer container. Next, the electrolyte solution was injected into an outer container. The resulting outer container was hermetically sealed to obtain a lithium secondary battery.

### Examples 2 to 47

Lithium secondary batteries were obtained in the same manner as in Example 1, except that each compound described in Tables 6 and 7 was used instead of 1H-benzotriazole as the negative-electrode coating agent. Each compound described in Tables 6 and 7 is represented by an abbreviation, and the correspondence relationship between the abbreviation for each compound, the compound name, the structural formula, and the number of Example used is shown in Tables 1 to 5.

### Examples 48 to 52

Lithium secondary batteries were obtained in the same manner as in Example 1, except that the negative electrode was produced as follows.

An Ni foil having a thickness of 10 μm was washed with a sulfamic-acid-containing solvent, and then washed with water. Subsequently, the Ni foil was immersed in a solution containing each compound described in Table 7 as the negative-electrode coating agent, dried, and further washed with water to obtain an Ni foil coated with the negative-electrode coating agent. The Ni foil thus obtained was punched into a predetermined size (45 mm×45 mm) to obtain a negative electrode. Each compound described in Table 7 is represented by an abbreviation, and the correspondence relationship between the abbreviation for each compound, the compound name, the structural formula, and the number of Example used is shown in Tables 1 to 5.

### Examples 53 to 57

Lithium secondary batteries were obtained in the same manner as in Example 1, except that the negative electrode was produced as follows.

A stainless steel (SUS) foil having a thickness of 10 μm was washed with a sulfamic-acid-containing solvent, and then washed with water. Subsequently, the stainless steel (SUS) foil was immersed in a solution containing each compound described in Table 7 as the negative-electrode coating agent, dried, and further washed with water to obtain a stainless steel (SUS) foil coated with the negative-electrode coating agent. The stainless steel (SUS) foil thus obtained was punched into a predetermined size (45 mm×45 mm) to obtain a negative electrode. Each compound described in Table 7 is represented by an abbreviation, and the correspondence relationship between the abbreviation for each compound, the compound name, the structural formula, and the number of Example used is shown in Tables 1 to 5.

### Examples 58 to 114

In Examples 58 to 114, lithium secondary batteries were obtained in the same manner as in Examples 1 to 57, except that electrolyte solution 2 prepared as follows was used instead of the electrolyte solution 1. Tables 8 and 9 show negative electrode materials used and negative-electrode coating agents. Each compound described in Tables 8 and 9 is represented by an abbreviation, and the correspondence relationship between the abbreviation for each compound, the compound name, the structural formula, and the number of Example used is shown in Tables 1 to 5.

### Comparative Example 1

A lithium secondary battery was obtained in the same manner as in Example 1, except that an electrolytic Cu foil having a thickness of 10 μm was washed with a sulfamic-acid-containing solvent, washed with water, punched into a predetermined size (45 mm×45 mm), and used as the negative electrode.

### Comparative Example 2

Lithium secondary batteries were obtained in the same manner as in Example 1, except that the negative electrode was produced as follows.

An electrolytic Cu foil having a thickness of 10 μm was washed with a sulfamic-acid-containing solvent, and then washed with water. Subsequently, the electrolytic Cu foil was immersed in a hydrochloric acid solution, dried, and further washed with water to obtain a Cu foil in which the surface was acid-treated. The Cu foil thus obtained was punched into a predetermined size (45 mm×45 mm) to obtain a negative electrode.

### Comparative Example 3

Lithium secondary batteries were obtained in the same manner as in Example 1, except that the negative electrode was produced as follows.

An electrolytic Cu foil having a thickness of 10 μm was washed with a sulfamic-acid-containing solvent, and then washed with water. Subsequently, the electrolytic Cu foil was immersed in a dilute sulfuric acid solution, dried, and further washed with water to obtain a Cu foil in which the surface was acid-treated. The Cu foil thus obtained was punched into a predetermined size (45 mm×45 mm) to obtain a negative electrode.

### Comparative Examples 4 to 6

In Comparative Examples 4 to 6, lithium secondary batteries were obtained in the same manner as in Comparative Examples 1 to 3, except that the electrolyte solution 2 was used instead of the electrolyte solution 1. Table 10 shows negative electrode materials used.

### Evaluation of Capacity and Cycle Characteristic

The capacity and cycle characteristic of each of the lithium secondary batteries produced in Examples and Comparative Examples were evaluated as follows.

The produced lithium secondary battery was CC-charged at 3.2 mA until the voltage reached 4.2 V (initial charge), and then CC-discharged at 3.2 mA until the voltage reached 3.0 V (which will hereinafter be called “initial discharge”). Next, a cycle of CC-charging at 13.6 mA until the voltage reached 4.2 V and then CC-discharging at 20.4 mA until the voltage reached 3.0 V was repeated at a temperature of 25° C. Tables 6 to 10 show the capacity (which will hereinafter be called “initial capacity”) obtained from the initial discharging for each example. For the examples, the number of cycles (referred to as “Number of cycles” in the table) when the discharge capacity reached 80% of the initial capacity is shown in Tables 6 to 10.

### Measurement of Direct Current Resistance

The produced lithium secondary battery was CC-charged at 5.0 mA to 4.2 V, and then CC-discharged at 30 mA, 60 mA, and 90 mA for 30 seconds, respectively. At this time, the lower limit voltage was set to 2.5 V, but in any of the examples, the voltage did not reach 2.5 V by the discharging for 30 seconds. In addition, between each discharging, CC-charging was performed again at 5.0 mA to 4.2 V, and the next CC-discharging was performed after the charging was completed. The direct current resistance (DCR) (unit: Ω) was obtained from the gradient of I-V characteristic obtained plotting a current value I and a voltage drop V obtained as described above, and linearly approximating each point. The results for each example are shown in Tables 6 to 10.

TABLE 1

| No. | 1 | 2 | 3 | 4 |
|---|---|---|---|---|
| Example | 1, 48, 53, 58, 105, 110 | 2, 49, 54, 59.106, 111 | 3, 50, 55, 60, 107, 112 | 4, 51, 56, 61, 108, 113 |
| Abbreviation | BTA | 5MBTA | 4MBTA | BZBTA |
| Compound name | 1H-benzotriazole | 5-methyl-1H-benzotriazole | 4-methyl-1H-benzotriazole | 1-benzoyl-1H-benzotriazole |
| Structural formula | 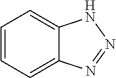 | 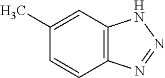 | 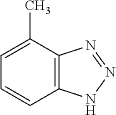 | 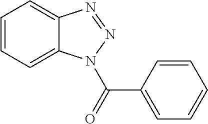 [SMILES: O=C(c1ccccc1)n1nnc2ccccc21] |
| | No. | 5 | 6 | 7 |
| | Example | 5, 52, 57, 62, 109, 114 | 6, 63 | 7, 64 |
| | Abbreviation | PCBTA | ABTAAB | 5ABTAATBA |
| | Compound name | 1-(2-pyridylcarbonyl)benzotriazole | 1-acetyl-1H-benzotriazole | 5-amino-1H-benzotriazole |
| | Structural formula | 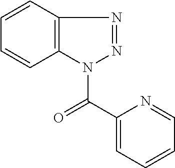 [SMILES: O=C(c1ccccn1)n1nnc2ccccc21] | 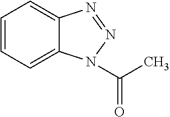 | 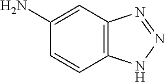 |

TABLE 2

| No. | 8 | 9 | 10 | 11 |
|---|---|---|---|---|
| Example | 8, 65 | 9, 66 | 10, 67 | 11, 68 |
| Abbreviation | MCPBTA | AMCPBTA | BIZ | PyBIZ |
| Compound name | 2-mercaptobenzothiazole | 6-amino-2-mercaptobenzothiazole | benzimidazole | 2-(2-pyridyl) benzimidazole |
| Structural formula | 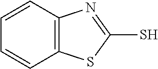 | 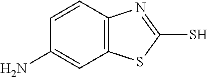 [SMILES: Nc1ccc2nc(S)sc2c1] | 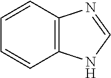 | 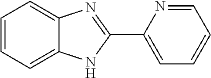 [SMILES: c1ccc(-c2nc3ccccc3[nH]2)nc1] |
| | | No. | 12 | 13 |
| | | Example | 12, 69 | 13, 70 |
| | | Abbreviation | BOZ | MBOZ |
| | | Compound name | benzoxazole | 2-methylbenzoxazole |
| | | Structural formula | 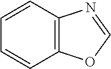 | 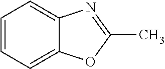 |

TABLE 3

| No. | 14 | 15 | 16 |
|---|---|---|---|
| Example | 14, 71 | 15, 72 | 16, 73 |
| Abbreviation | CBTA | BTACA | NPBTACA |
| Compound name | benzotriazole-5-carboxylic acid | benzotriazole-1-carboxamide | N-(2-propenyl)-1H- |
| | | | benzotriazole-1-carbothioamide |
| Structural formula | 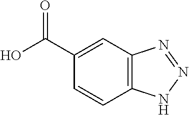 [SMILES: O=C(O)c1ccc2[nH]nnc2c1] | 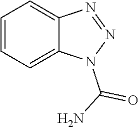 [SMILES: NC(=O)n1nnc2ccccc21] | 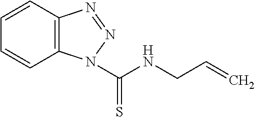 |
| No. | 17 | 18 | 19 |
| Example | 17, 74 | 18, 75 | 19, 76 |
| Abbreviation | NTBTACT | NBBTACA | 1PBTA |
| Compound name | N-(2-thiazolyl)-1H- | N-benzyl-1H- | 1-propargyl-1H- |
| | carbothioamide | benzotriazole-1-carbothioamide | benzotriazole |
| Structural formula | 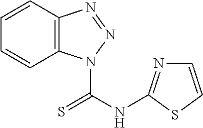 [SMILES: S=C(Nc1nccs1)n1nnc2ccccc21] | 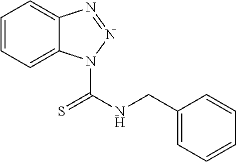 [SMILES: S=C(NCc1ccccc1)n1nnc2ccccc21] | 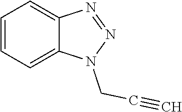 |
| No. | 20 | 21 | 22 |
| Example | 20, 77 | 21, 78 | 22, 79 |
| Abbreviation | BTAS | BTAAN | 3HBTACA |
| Compound name | 1H-benzotriazole-4-sulfonic acid | 1H-benzotriazole-1-acetonitrile | 3H-benzotriazole-5-carboxylic acid |
| Structural formula | 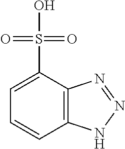 [SMILES: O=S(=O)(O)c1cccc2[nH]nnc12] | 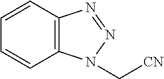 [SMILES: N#CCn1nnc2ccccc21] | 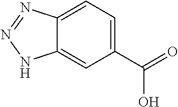 [SMILES: O=C(O)c1ccc2nn[nH]c2c1] |
| No. | 23 | 24 | 25 |
| Example | 23, 80 | 24, 81 | 25, 82 |
| Abbreviation | 5BRBTA | 2OH5MEBTA | 1C1HBTA |
| Compound name | 5-bromo-1H-benzotriazole | 2-(2-hydroxy-5-methylphenyl) | 1-(chloromethyl)-1H-benzotriazole |
| | | benzotriazole | |
| Structural formula | 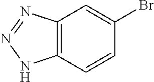 | 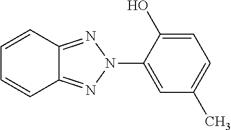 [SMILES: Cc1ccc(O)c(-n2nc3ccccc3n2)c1] | 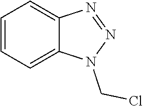 [SMILES: ClCn1nnc2ccccc21] |

TABLE 4

| No. | 26 | 27 | 28 |
|---|---|---|---|
| Example | 26, 83 | 27, 84 | 28, 85 |
| Abbreviation | MSBTA | TMSMBTA | PMBTA |
| Compound name | 1-(methylsulfonyl)-1H-benzotriazole | 1-[(trimethylsilyl)methyl]benzotriazole | 1-(phenoxymethyl)-1H-benzotriazole |
| Structural formula | 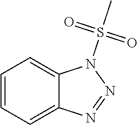 | 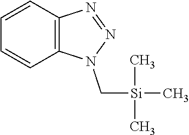 | 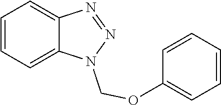 [SMILES: c1ccc(OCn2nnc3ccccc32)cc1] |
| No. | 29 | 30 | 31 |
| Example | 29, 86 | 30, 87 | 31, 88 |
| Abbreviation | TMSTBA | PSBTA | M1ISBTA |
| Compound name | 1-(trimethylsilyl)-1H-benzotriazole | 1-(phenylsulfonyl)-1H-benzotriazole | 1-[(1-methyl-1H-imidazole-2- |
| | | | yl)sulfonyl]-1H-benzotriazole |
| Structural formula | 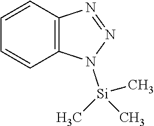 | 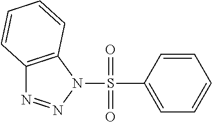 [SMILES: O=S(=O)(c1ccccc1)n1nnc2ccccc21] | 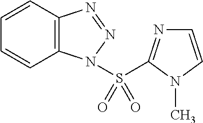 [SMILES: Cn1ccnc1S(=O)(=O)n1nnc2ccccc21] |
| No. | 32 | 33 | 34 |
| Example | 32, 89 | 33, 90 | 34, 91 |
| Abbreviation | PySTBA | CBTBA | MMBTA |
| Compound name | 1-(2-pyridinylsulfonyl)- | 1-(4-chlorobenzoyl)- | 1-(methoxymethyl)- |
| | 1H-benzotriazole | 1H-benzotriazole | 1H-benzotriazole |
| Structural formula | 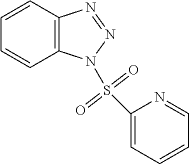 [SMILES: O=S(=O)(c1ccccn1)n1nnc2ccccc21] | 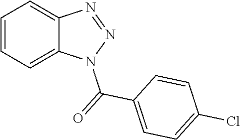 [SMILES: O=C(c1ccc(Cl)cc1)n1nnc2ccccc21] | 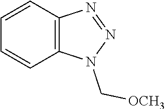 [SMILES: COCn1nnc2ccccc21] |
| No. | 35 | 36 | 37 |
| Example | 35, 92 | 36, 93 | 37, 94 |
| Abbreviation | TSBTA | PSBTA | TFMBTA |
| Compound name | 1-(2-thienylsulfonyl)- | 1-(3-pyridinylsulfonyl)- | 5-(trifluoromethyl)-1H- |
| | 1H-benzotriazole | 1H-benzotriazole | 1,2,3-benzotriazole |
| Structural formula | 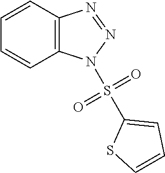 [SMILES: O=S(=O)(c1cccs1)n1nnc2ccccc21] | 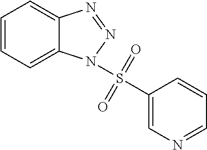 [SMILES: O=S(=O)(c1cccnc1)n1nnc2ccccc21] | 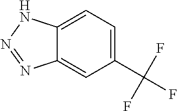 [SMILES: FC(F)(F)c1ccc2[nH]nnc2c1] |

TABLE 5

| No. | 38 | 39 | 40 |
|---|---|---|---|
| Example | 38, 95 | 39, 96 | 40, 97 |
| Abbreviation | BBTAMT | BTAPyMT | NCyBTA |
| Compound name | bis(1-benzotriazolyl)methanethione | benzotriazol-1-ylpyrrolidin-1- | 1-(1-napththylcarbonyl)-1H- |
| | | ylmethanethione | benzotriazole |
| Structural formula | 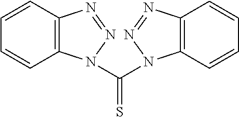 [SMILES: S=C(n1nnc2ccccc21)n1nnc2ccccc21] | 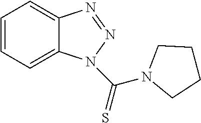 [SMILES: S=C(N1CCCC1)n1nnc2ccccc21] | 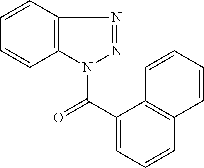 [SMILES: O=C(c1cccc2ccccc12)n1nnc2ccccc21] |
| No. | 41 | 42 | 43 |
| Example | 41, 98 | 42, 99 | 43, 100 |
| Abbreviation | MABTA | ByBTA | NPBTACA |
| Compound name | 1-(2-methyl-allyl)-1H-benzotriazole | 1-(benzyloxy)-1H-1,2,3- | N-phenyl-1H-1,2,3-benzotriazole-1- |
| | | benzotriazole | carboxamide |
| Structural formula | 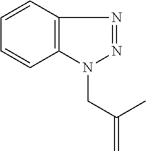 | 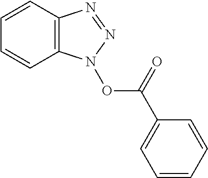 [SMILES: O=C(On1nnc2ccccc21)c1ccccc1] | 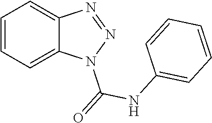 [SMILES: O=C(Nc1ccccc1)n1nnc2ccccc21] |
| No. | 44 | 45 | 46 |
| Example | 44, 101 | 45, 102 | 46, 103 |
| Abbreviation | PyBTAC | MBTAA | TrBTAM |
| Compound name | phenyl 1H-1,2,3-benzotriazole-5- | 1-methyl-1H-1,2,3-benzotriazole- | tris-(1-benzotriazolyl)methane |
| | carboxylate | 5-amine | |
| Structural formula | 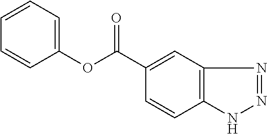 [SMILES: O=C(Oc1ccccc1)c1ccc2[nH]nnc2c1] | 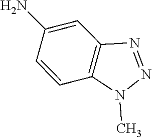 | 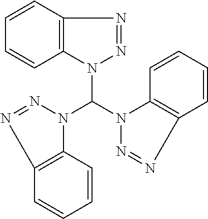 [SMILES: c1ccc2c(c1)nnn2C(n1nnc2ccccc21)n1nnc2ccccc21] |

| No. | 47 |
|---|---|
| Example | 47, 104 |
| Abbreviation | 26BBTAMMP |
| Compound name | 2,6-bis[(1H-benzotriazole-1-yl)methyl]-4- |
| | methylphenol |
| Structural formula | 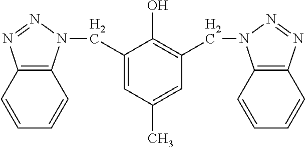 [SMILES: Cc1cc(Cn2nnc3ccccc32)c(O)c(Cn2nnc3ccccc32)c1] |

TABLE 6

| | Negative electrode | | | | Direct | |
|---|---|---|---|---|---|---|
| | Negative | | | Initial | current | Number of |
| | electrode | Negative-electrode | Electrolyte | capacity | resistance | cycles |
| Sample No. | material | coating agent | solution | (mAh) | (Ω) | (times) |
| Example 1 | Cu | BTA | Electrolyte | 61 | 4.30 | 182 |
| | | | solution 1 | | | |
| Example 2 | Cu | 5MBTA | Electrolyte | 59 | 4.25 | 155 |
| | | | solution 1 | | | |
| Example 3 | Cu | 4MBTA | Electrolyte | 58 | 4.35 | 154 |
| | | | solution 1 | | | |
| Example 4 | Cu | BZBTA | Electrolyte | 60 | 4.55 | 156 |
| | | | solution 1 | | | |
| Example 5 | Cu | PCBTA | Electrolyte | 62 | 4.52 | 151 |
| | | | solution 1 | | | |
| Example 6 | Cu | ABTAAB | Electrolyte | 61 | 4.50 | 152 |
| | | | solution 1 | | | |
| Example 7 | Cu | 5ABTAABTA | Electrolyte | 63 | 4.46 | 153 |
| | | | solution 1 | | | |
| Example 8 | Cu | MCPBTA | Electrolyte | 62 | 4.43 | 155 |
| | | | solution 1 | | | |
| Example 9 | Cu | AMCPBTA | Electrolyte | 62 | 4.47 | 156 |
| | | | solution 1 | | | |
| Example 10 | Cu | BIZ | Electrolyte | 63 | 4.55 | 158 |
| | | | solution 1 | | | |
| Example 11 | Cu | PyBIZ | Electrolyte | 64 | 4.56 | 154 |
| | | | solution 1 | | | |
| Example 12 | Cu | BOZ | Electrolyte | 61 | 4.54 | 152 |
| | | | solution 1 | | | |
| Example 13 | Cu | MBOZ | Electrolyte | 60 | 4.53 | 155 |
| | | | solution 1 | | | |
| Example 14 | Cu | CBTA | Electrolyte | 62 | 4.52 | 149 |
| | | | solution 1 | | | |
| Example 15 | Cu | BTACA | Electrolyte | 61 | 4.58 | 148 |
| | | | solution 1 | | | |
| Example 16 | Cu | NPBTACA | Electrolyte | 63 | 4.66 | 148 |
| | | | solution 1 | | | |
| Example 17 | Cu | NTBTACT | Electrolyte | 60 | 4.48 | 149 |
| | | | solution 1 | | | |
| Example 18 | Cu | NBBTACA | Electrolyte | 60 | 4.51 | 147 |
| | | | solution 1 | | | |
| Example 19 | Cu | 1PBTA | Electrolyte | 62 | 4.53 | 146 |
| | | | solution 1 | | | |
| Example 20 | Cu | BTAS | Electrolyte | 63 | 4.58 | 148 |
| | | | solution 1 | | | |
| Example 21 | Cu | BTAAN | Electrolyte | 64 | 4.55 | 149 |
| | | | solution 1 | | | |
| Example 22 | Cu | 3HBTACA | Electrolyte | 62 | 4.56 | 143 |
| | | | solution 1 | | | |
| Example 23 | Cu | 5BRBTA | Electrolyte | 63 | 4.41 | 148 |
| | | | solution 1 | | | |
| Example 24 | Cu | 2OH5MEBTA | Electrolyte | 61 | 4.43 | 151 |
| | | | solution 1 | | | |
| Example 25 | Cu | 1C1HBTA | Electrolyte | 62 | 4.77 | 150 |
| | | | solution 1 | | | |
| Example 26 | Cu | MSBTA | Electrolyte | 60 | 4.48 | 151 |
| | | | solution 1 | | | |
| Example 27 | Cu | TMSMBTA | Electrolyte | 62 | 4.78 | 152 |
| | | | solution 1 | | | |
| Example 28 | Cu | PMBTA | Electrolyte | 62 | 4.71 | 153 |
| | | | solution 1 | | | |
| Example 29 | Cu | TMSTBA | Electrolyte | 60 | 4.81 | 151 |
| | | | solution 1 | | | |
| Example 30 | Cu | PSBTA | Electrolyte | 64 | 4.73 | 152 |
| | | | solution 1 | | | |

TABLE 7

| | Negative electrode | | | | Direct | |
|---|---|---|---|---|---|---|
| | Negative | | | Initial | current | Number of |
| | electrode | Negative-electrode | Electrolyte | capacity | resistance | cycles |
| Sample No. | material | coating agent | solution | (mAh) | (Ω) | (times) |
| Example 31 | Cu | M1ISBTA | Electrolyte | 63 | 4.76 | 153 |
| | | | solution 1 | | | |
| Example 32 | Cu | PySTBA | Electrolyte | 63 | 4.76 | 151 |
| | | | solution 1 | | | |
| Example 33 | Cu | CBTBA | Electrolyte | 62 | 4.51 | 152 |
| | | | solution 1 | | | |
| Example 34 | Cu | MMBTA | Electrolyte | 60 | 4.53 | 154 |
| | | | solution 1 | | | |
| Example 35 | Cu | TSBTA | Electrolyte | 61 | 4.81 | 151 |
| | | | solution 1 | | | |
| Example 36 | Cu | PSBTA | Electrolyte | 60 | 4.61 | 152 |
| | | | solution 1 | | | |
| Example 37 | Cu | TFMBTA | Electrolyte | 60 | 4.62 | 152 |
| | | | solution 1 | | | |
| Example 38 | Cu | BBTAMT | Electrolyte | 62 | 4.71 | 152 |
| | | | solution 1 | | | |
| Example 39 | Cu | BTAPyMT | Electrolyte | 64 | 4.44 | 153 |
| | | | solution 1 | | | |
| Example 40 | Cu | NCyBTA | Electrolyte | 63 | 4.33 | 154 |
| | | | solution 1 | | | |
| Example 41 | Cu | MABTA | Electrolyte | 61 | 4.35 | 156 |
| | | | solution 1 | | | |
| Example 42 | Cu | ByBTA | Electrolyte | 62 | 4.61 | 157 |
| | | | solution 1 | | | |
| Example 43 | Cu | NPBTACA | Electrolyte | 62 | 4.68 | 151 |
| | | | solution 1 | | | |
| Example 44 | Cu | PyBTAC | Electrolyte | 63 | 4.71 | 151 |
| | | | solution 1 | | | |
| Example 45 | Cu | MBTAA | Electrolyte | 64 | 4.81 | 152 |
| | | | solution 1 | | | |
| Example 46 | Cu | TrBTAM | Electrolyte | 61 | 4.73 | 153 |
| | | | solution 1 | | | |
| Example 47 | Cu | 26BBTAMMP | Electrolyte | 61 | 4.33 | 157 |
| | | | solution 1 | | | |
| Example 48 | Ni | BTA | Electrolyte | 62 | 4.35 | 158 |
| | | | solution 1 | | | |
| Example 49 | Ni | 5MBTA | Electrolyte | 62 | 4.45 | 159 |
| | | | solution 1 | | | |
| Example 50 | Ni | 4MBTA | Electrolyte | 63 | 4.61 | 151 |
| | | | solution 1 | | | |
| Example 51 | Ni | BZBTA | Electrolyte | 61 | 4.53 | 152 |
| | | | solution 1 | | | |
| Example 52 | Ni | PCBTA | Electrolyte | 60 | 4.55 | 152 |
| | | | solution 1 | | | |
| Example 53 | SUS | BTA | Electrolyte | 60 | 4.66 | 152 |
| | | | solution 1 | | | |
| Example 54 | SUS | 5MBTA | Electrolyte | 61 | 4.81 | 153 |
| | | | solution 1 | | | |
| Example 55 | SUS | 4MBTA | Electrolyte | 62 | 4.59 | 151 |
| | | | solution 1 | | | |
| Example 56 | SUS | BZBTA | Electrolyte | 62 | 4.67 | 154 |
| | | | solution 1 | | | |
| Example 57 | SUS | PCBTA | Electrolyte | 63 | 4.45 | 152 |
| | | | solution 1 | | | |

TABLE 8

| | Negative electrode | | | | Direct | |
|---|---|---|---|---|---|---|
| | Negative | | | Initial | current | Number of |
| | electrode | Negative-electrode | Electrolyte | capacity | resistance | cycles |
| Sample No. | material | coating agent | solution | (mAh) | (Ω) | (times) |
| Example 58 | Cu | BTA | Electrolyte | 68 | 3.88 | 178 |
| | | | solution 2 | | | |
| Example 59 | Cu | 5MBTA | Electrolyte | 68 | 3.91 | 181 |
| | | | solution 2 | | | |
| Example 60 | Cu | 4MBTA | Electrolyte | 68 | 3.70 | 191 |
| | | | solution 2 | | | |
| Example 61 | Cu | BZBTA | Electrolyte | 68 | 3.84 | 168 |
| | | | solution 2 | | | |
| Example 62 | Cu | PCBTA | Electrolyte | 67 | 3.88 | 179 |
| | | | solution 2 | | | |
| Example 63 | Cu | ABTAAB | Electrolyte | 68 | 3.91 | 177 |
| | | | solution 2 | | | |
| Example 64 | Cu | 5ABTAABTA | Electrolyte | 67 | 3.82 | 181 |
| | | | solution 2 | | | |
| Example 65 | Cu | MCPBTA | Electrolyte | 67 | 3.84 | 184 |
| | | | solution 2 | | | |
| Example 66 | Cu | AMCPBTA | Electrolyte | 67 | 3.93 | 187 |
| | | | solution 2 | | | |
| Example 67 | Cu | BIZ | Electrolyte | 66 | 3.76 | 186 |
| | | | solution 2 | | | |
| Example 68 | Cu | PyBIZ | Electrolyte | 69 | 3.78 | 188 |
| | | | solution 2 | | | |
| Example 69 | Cu | BOZ | Electrolyte | 68 | 3.90 | 175 |
| | | | solution 2 | | | |
| Example 70 | Cu | MBOZ | Electrolyte | 67 | 4.00 | 187 |
| | | | solution 2 | | | |
| Example 71 | Cu | CBTA | Electrolyte | 67 | 4.10 | 189 |
| | | | solution 2 | | | |
| Example 72 | Cu | BTACA | Electrolyte | 69 | 4.20 | 188 |
| | | | solution 2 | | | |
| Example 73 | Cu | NPBTACA | Electrolyte | 68 | 4.30 | 185 |
| | | | solution 2 | | | |
| Example 74 | Cu | NTBTACT | Electrolyte | 67 | 3.96 | 176 |
| | | | solution 2 | | | |
| Example 75 | Cu | NBBTACA | Electrolyte | 67 | 3.55 | 176 |
| | | | solution 2 | | | |
| Example 76 | Cu | 1PBTA | Electrolyte | 69 | 3.65 | 175 |
| | | | solution 2 | | | |
| Example 77 | Cu | BTAS | Electrolyte | 68 | 3.54 | 179 |
| | | | solution 2 | | | |
| Example 78 | Cu | BTAAN | Electrolyte | 68 | 3.57 | 184 |
| | | | solution 2 | | | |
| Example 79 | Cu | 3HBTACA | Electrolyte | 67 | 3.58 | 188 |
| | | | solution2 | | | |
| Example 80 | Cu | 5BRBTA | Electrolyte | 68 | 3.54 | 182 |
| | | | solution2 | | | |
| Example 81 | Cu | 2OH5MEBTA | Electrolyte | 67 | 3.66 | 181 |
| | | | solution 2 | | | |
| Example 82 | Cu | 1C1HBTA | Electrolyte | 69 | 3.56 | 188 |
| | | | solution 2 | | | |
| Example 83 | Cu | MSBTA | Electrolyte | 68 | 3.48 | 178 |
| | | | solution 2 | | | |
| Example 84 | Cu | TMSMBTA | Electrolyte | 67 | 3.44 | 179 |
| | | | solution 2 | | | |
| Example 85 | Cu | PMBTA | Electrolyte | 67 | 3.52 | 181 |
| | | | solution 2 | | | |
| Example 86 | Cu | TMSTBA | Electrolyte | 66 | 3.84 | 182 |
| | | | solution 2 | | | |
| Example 87 | Cu | PSBTA | Electrolyte | 69 | 4.10 | 188 |
| | | | solution 2 | | | |

TABLE 9

| | Negative electrode | | | | Direct | |
|---|---|---|---|---|---|---|
| | Negative | | | Initial | current | Number of |
| | electrode | Negative-electrode | Electrolyte | capacity | resistance | cycles |
| Sample No. | material | coating agent | solution | (mAh) | (Ω) | (times) |
| Example 88 | Cu | M1ISBTA | Electrolyte | 67 | 4.05 | 166 |
| | | | solution 2 | | | |
| Example 89 | Cu | PySTBA | Electrolyte | 68 | 4.08 | 168 |
| | | | solution 2 | | | |
| Example 90 | Cu | CBTBA | Electrolyte | 68 | 3.77 | 171 |
| | | | solution 2 | | | |
| Example 91 | Cu | MMBTA | Electrolyte | 68 | 3.78 | 144 |
| | | | solution 2 | | | |
| Example 92 | Cu | TSBTA | Electrolyte | 67 | 3.67 | 175 |
| | | | solution 2 | | | |
| Example 93 | Cu | PSBTA | Electrolyte | 67 | 3.55 | 174 |
| | | | solution 2 | | | |
| Example 94 | Cu | TFMBTA | Electrolyte | 67 | 3.99 | 173 |
| | | | solution 2 | | | |
| Example 95 | Cu | BBTAMT | Electrolyte | 67 | 4.05 | 171 |
| | | | solution 2 | | | |
| Example 96 | Cu | BTAPyMT | Electrolyte | 69 | 4.30 | 168 |
| | | | solution 2 | | | |
| Example 97 | Cu | NCyBTA | Electrolyte | 68 | 4.05 | 169 |
| | | | solution 2 | | | |
| Example 98 | Cu | MABTA | Electrolyte | 66 | 3.98 | 167 |
| | | | solution 2 | | | |
| Example 99 | Cu | ByBTA | Electrolyte | 67 | 4.01 | 172 |
| | | | solution 2 | | | |
| Example 100 | Cu | NPBTACA | Electrolyte | 67 | 4.05 | 173 |
| | | | solution 2 | | | |
| Example 101 | Cu | PyBTAC | Electrolyte | 68 | 4.03 | 172 |
| | | | solution 2 | | | |
| Example 102 | Cu | MBTAA | Electrolyte | 67 | 3.98 | 177 |
| | | | solution 2 | | | |
| Example 103 | Cu | TrBTAM | Electrolyte | 67 | 3.89 | 178 |
| | | | solution 2 | | | |
| Example 104 | Cu | 26BBTAMMP | Electrolyte | 66 | 3.77 | 173 |
| | | | solution 2 | | | |
| Example 105 | Ni | BTA | Electrolyte | 67 | 3.89 | 181 |
| | | | solution 2 | | | |
| Example 106 | Ni | 5MBTA | Electrolyte | 67 | 4.05 | 180 |
| | | | solution 2 | | | |
| Example 107 | Ni | 4MBTA | Electrolyte | 68 | 4.06 | 179 |
| | | | solution 2 | | | |
| Example 108 | Ni | BZBTA | Electrolyte | 69 | 4.01 | 178 |
| | | | solution 2 | | | |
| Example 109 | Ni | PCBTA | Electrolyte | 67 | 4.03 | 190 |
| | | | solution 2 | | | |
| Example 110 | SUS | BTA | Electrolyte | 67 | 4.01 | 189 |
| | | | solution 2 | | | |
| Example 111 | SUS | 5MBTA | Electrolyte | 68 | 3.99 | 188 |
| | | | solution2 | | | |
| Example 112 | SUS | 4MBTA | Electrolyte | 67 | 3.97 | 188 |
| | | | solution 2 | | | |
| Example 113 | SUS | BZBTA | Electrolyte | 68 | 3.96 | 178 |
| | | | solution 2 | | | |
| Example 114 | SUS | PCBTA | Electrolyte | 66 | 3.98 | 187 |
| | | | solution 2 | | | |

TABLE 10

| | Negative electrode | | | | Direct | |
|---|---|---|---|---|---|---|
| | Negative | | | Initial | current | Number of |
| | electrode | Negative-electrode | Electrolyte | capacity | resistance | cycles |
| Sample No. | material | coating agent | solution | (mAh) | (Ω) | (times) |
| Comparative | Cu | None | Electrolyte | 55 | 5.46 | 9 |
| Example 1 | | | solution 1 | | | |
| Comparative | Cu | None (hydrochloric acid | Electrolyte | 59 | 5.05 | 8 |
| Example 2 | | treatment) | solution 1 | | | |
| Comparative | Cu | None (sulfuric acid | Electrolyte | 57 | 5.22 | 7 |
| Example 3 | | treatment) | solution 1 | | | |
| Comparative | Cu | None | Electrolyte | 64 | 4.43 | 10 |
| Example 4 | | | solution 2 | | | |
| Comparative | Cu | None (hydrochloric acid | Electrolyte | 65 | 3.68 | 20 |
| Example 5 | | treatment) | solution 2 | | | |
| Comparative | Cu | None (sulfuric acid | Electrolyte | 67 | 3.88 | 10 |
| Example 6 | | treatment) | solution 2 | | | |

From Tables 6 to 10, in Examples 1 to 114 in which the negative electrode coated with the negative-electrode coating agent was used, as compared with Comparative Examples 1 to 6 in which the negative electrode was not used, it was found that the number of cycles was higher and the cycle characteristic was excellent. In addition, in Examples 1 to 114 in which the negative electrode coated with the negative-electrode coating agent was used, as compared with Comparative Examples 1 to 6 in which the negative electrode was not used, it was found that the direct current resistance was the same level and the rate capability did not deteriorate even if the negative-electrode coating agent was applied. That is, it was found that the lithium secondary battery of the present invention was excellent in cycle characteristic and rate capability.

From Tables 6 to 10, in the lithium secondary battery having the negative electrode coated with the negative-electrode coating agent, it was found that, by using electrolyte solution containing, as a solvent, the compound having at least one of the monovalent group represented by Formula (A) or the monovalent group represented by Formula (B), the cycle characteristic was further improved.

The lithium secondary battery of the present invention has a high energy density and an excellent cycle characteristic so that it has industrial applicability as a power storage device to be used for various uses.

100, 200, 300 . . . lithium secondary battery

110 . . . positive electrode current collector

120 . . . positive electrode

130 . . . negative electrode

140 . . . separator

210 . . . negative electrode terminal

220 . . . positive electrode terminal

310 . . . solid electrolyte

What is claimed is:

1. A lithium secondary battery, comprising:
a positive electrode; and
a negative electrode not having a negative electrode active material,
wherein at least a part of a surface of the negative electrode facing the positive electrode is coated with a compound containing an aromatic ring to which two or more elements selected from the group consisting of N, S, and O are each independently bonded.

2. The lithium secondary battery according to claim 1, further comprising:
a separator or a solid electrolyte placed between the positive electrode and the negative electrode.

3. The lithium secondary battery according to claim 1, wherein one or more N are bonded to the aromatic ring.

4. The lithium secondary battery according to claim 1, wherein the compound is at least one selected from the group consisting of a compound represented by Formula (1) and a derivative thereof. 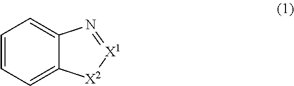
(in the formula,
X¹ represents any one of C to which X³ is bonded or N,
X² represents any one of N to which X⁴ is bonded, S, or O,
X³ represents -R¹, -NR¹₂, -OR¹, or -SR¹,
X⁴ represents any one of -R², -CO-X, -CS-NX₂, or -OX,
R¹ represents a hydrogen atom, an unsubstituted monovalent hydrocarbon group, or a pyridyl group,
R² represents a hydrogen atom or a monovalent hydrocarbon group which is optionally substituted, and
X represents a monovalent substituent.)

5. The lithium secondary battery according to claim 1, wherein the compound is at least one selected from the group consisting of benzotriazole, benzimidazole, benzimidazolethiol, benzoxazole, benzoxazolethiol, benzothiazole, mercaptobenzothiazole, and derivatives thereof.

6. The lithium secondary battery according to claim 4, wherein the derivative is a compound in which one or more substituents selected from the group consisting of a hydrocarbon group which is optionally substituted, an amino group which is optionally substituted, a carboxy group, a sulfo group, and a halogen group are each independently bonded to the aromatic ring.

7. The lithium secondary battery according to claim 1, further comprising:
electrolyte solution containing, as a solvent, a compound having at least one of a monovalent group represented by Formula (A) or a monovalent group represented by Formula (B). 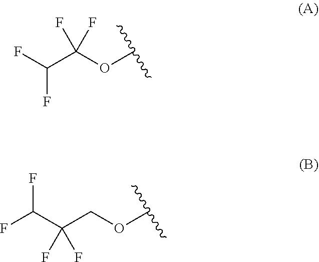 [SMILES: *OC(F)(F)C(F)F ; *OCC(F)(F)C(F)F]
(in the formulae, a wavy line represents a bonding site in the monovalent group.)

8. The lithium secondary battery according to claim 1, wherein the lithium secondary battery is a lithium secondary battery in which charging and discharging are performed by depositing lithium metal on the surface of the negative electrode and electrolytically dissolving the deposited lithium.

9. The lithium secondary battery according to claim 1, wherein the negative electrode is an electrode consisting of at least one selected from the group consisting of Cu, Ni, Ti, Fe, and other metals that do not react with Li, alloys thereof, and stainless steel (SUS).

10. The lithium secondary battery according to claim 1, wherein the negative electrode does not have a lithium metal on a surface of the negative electrode before initial charge and/or at an end of discharge.

11. The lithium secondary battery according to claim 1, wherein the battery has an energy density of 350 Wh/kg or more.
